(19) United States
(12) Patent Application Publication
(10) Pub. No.: US 2018/0315444 A1
(43) Pub. Date: Nov. 1, 2018

(54) Signal Processing Method and Signal Processing Device

(71) Applicant: Yamaha Corporation, Hamamatsu-shi (JP)

(72) Inventor: Ryunosuke DAIDO, Hamamatsu-shi (JP)

(21) Appl. No.: 16/028,629

(22) Filed: Jul. 6, 2018

Related U.S. Application Data
(63) Continuation of application No. PCT/JP2016/088935, filed on Dec. 27, 2016.

(30) Foreign Application Priority Data
Jan. 6, 2016 (JP) 2016-001370
Mar. 25, 2016 (JP) 2016-061928

(51) Int. Cl. G10L 25/90

(52) U.S. Cl. CPC G10L 25/90

(57) ABSTRACT

A signal processing device includes a plurality of harmonics attenuation filters configured to have different bandpass characteristics and configured to generate signals to be used for estimation of a fundamental frequency of an input signal by restricting the bandwidth of the input signal. Each of the harmonics attenuation filters comprises a filter that has an accumulator and a comb filter which are connected in cascade. The accumulator is configured to accumulate input signals thereto. The comb filter is configured to output a difference between an input signal to the comb filter and a signal obtained by delaying the input signal to the comb filter.

### CROSS REFERENCE TO RELATED APPLICATIONS

This application is a continuation of PCT application No. PCT/JP2016/088935, which was filed on Dec. 27, 2016 based on Japanese Patent Application (No. 2016-001370) filed on Jan. 6, 2016 and Japanese Patent Application (No. 2016-061928) filed on Mar. 25, 2016, the contents of which are incorporated herein by reference.

### BACKGROUND OF THE INVENTION

### 1. Field of the Invention

The present disclosure relates to a signal processing technology and, more particularly, to a signal processing method and a signal processing device that are suitable to estimate a fundamental frequency of a sound signal.

### 2. Description of the Related Art

The fundamental frequency is a quantity that has a strong relationship with the sound pitch as recognized by humans and hence its value is, in itself, highly valuable in use. The fundamental frequency is used for intonation analysis of ordinary conversations, pitch analysis of singing voices (for example, in karaoke marking), representation of pitch information in sound encoding, and other purposes. Also in recent high-quality sound analyses, the fundamental frequency plays an important role as auxiliary information for analysis.

However, in general, it is difficult to estimate a fundamental frequency of a sound. One factor that renders estimation of a fundamental frequency difficult is presence of higher harmonic components (also called overtone components) that are contained in a sound together with a fundamental frequency component. One method for determining a fundamental frequency of a sound would be to remove higher harmonic components from the sound using a lowpass filter or the like. However, since the fundamental frequency itself is unknown, it is impossible to determine a cutoff frequency of a lowpass filter for removing higher harmonic components.

Non-patent document 1 discloses a technique for solving the above problem. In the technique disclosed in Non-patent document 1, an input signal whose fundamental frequency is unknown is given to plural lowpass filters that are different from each other in cutoff frequency. Each of the plural lowpass filters serves to attenuate higher harmonic components whose frequencies are higher than its cutoff frequency if the input signal contains them. Thus, in the following description, for the sake of convenience, such lowpass filters will be referred to as “harmonics attenuation filters.” In the technique disclosed in Non-patent document 1, a fundamental frequency of an input signal is determined by estimating its fundamental periods based on output signals of plural harmonics attenuation filters and selecting a most reliable one from estimation results.

The details of Non-patent document 1 and Non-patent document 2 are as follows.

Non-patent document 1: Masanori Morise, Hideki Kawahara, and Takanobu Nishiura: “High-speed FO estimation method for a large-SNR sound based on detection of a fundamental wave,” The Transactions of the Institute of Electronics, Information and Communication Engineers, The Institute of Electronics, Information and Communication Engineers, Feb. 1, 2010, Vol. J93-D, No. 2, pp. 109-117.

Non-patent document 2: Thomas Drugman and Thierry Dutoit: “Glottal closure and opening instant detection from speech signals,” In: Interspeech, 2009, pp. 2891-2894.

### SUMMARY OF THE INVENTION

Incidentally, in the above-described conventional technique, to estimate a fundamental frequency of an input signal correctly, it is necessary to provide many harmonics attenuation filters. Thus, to realize a function for estimating a fundamental frequency by computation processing that is performed by a signal processing device, a problem arises that the computation amount of the signal processing device becomes so large that it is difficult to estimate a fundamental frequency of an input signal at high speed. On the other hand, a case of realizing a function for estimating a fundamental frequency by hardware such as electronic circuits is associated with a problem that the hardware scale becomes so large that the hardware is made expensive.

The present disclosure has been made in view of the above circumstances, and an object of the disclosure is therefore to provide a technical means for signal processing that can reduce the amount of computation or be implemented by small-scale hardware and estimate a fundamental frequency of an input signal at high speed.

The disclosure provides a signal processing method including a plurality of harmonics attenuation filtering processes of generating respective signals to be used for estimation of a fundamental frequency of an input signal by performing bandwidth restriction on the input signal according to different bandpass characteristics, wherein in each of the harmonics attenuation filtering processes, a filtering process including an accumulation process and a comb filter process an output signal of one of which becomes an input signal of the other of which is executed once or plural times recursively; wherein the accumulation process accumulates input signals input thereto; and wherein the comb filter process outputs a difference between an input signal to the comb filter process and a signal obtained by delaying the input signal to the comb filter process.

The disclosure provides another signal processing method including: a state detection process of detecting, while selecting a detection target state from plural kinds of states of an input signal in prescribed order, the detection target state from the input signal; and a period estimation process of estimating a period of the input signal based on state detection times of the state detection process.

The disclosure provides still another signal processing method including: a selection process of receiving, from a plurality of fundamental wave estimators, pieces of fundamental wave information that are estimation results relating to a fundamental wave component of an input signal and selecting one of the pieces of fundamental wave information, wherein the selection process selects one of the pieces of fundamental wave information using a cost function that has, as an independent variable, a difference between fundamental wave information as a preceding selection result and fundamental wave information received from each of the fundamental wave estimators, and the cost function being nonlinear with respect to the difference.

The disclosure provides a further signal processing method including: a plurality of harmonics attenuation filtering processes of performing bandwidth restriction on an input signal according to different bandpass characteristics and producing bandwidth-restricted output signals; a plurality of fundamental wave estimation processes of estimating fundamental wave components of the input signal based on the output signals of the plural harmonics attenuation filtering processes, respectively; a plurality of pitch mark estimation processes, each of which estimates a pitch mark in each period of the fundamental wave component estimated by the associated one of the plural fundamental wave estimation processes, based on the output signal of the associated one of the plural harmonics attenuation filtering processes; and a selection process of selecting a fundamental wave component and a pitch mark that are estimated based on an output signal of a common harmonics attenuation filtering process from the fundamental wave components estimated by the plural respective fundamental wave estimation processes and the pitch marks estimated by the plural respective pitch mark estimation processes.

The disclosure makes it possible to produce signals that can be used for estimation of a fundamental frequency by a smaller number of harmonics attenuation filters or harmonics attenuation filtering steps. As such, the disclosure makes it possible to reduce the amount of computation or the scale of hardware for estimation of a fundamental frequency and to estimate a fundamental frequency at high speed.

### BRIEF DESCRIPTION OF THE DRAWINGS

FIG. 1 is a block diagram showing the functional configuration of a signal processing device according to a first embodiment of the present disclosure.

FIG. 2 is a block diagram showing an example functional configuration of a harmonics attenuation filter employed in the first embodiment.

FIG. 3 is a graph showing an example frequency-amplitude characteristic of the same cyclic moving average filter.

FIG. 4 is a graph showing another example frequency-amplitude characteristic of the same cyclic moving average filter.

FIG. 5 is a block diagram showing an example configuration of a downsampler employed in the first embodiment.

FIG. 6 is a block diagram showing a basic configuration of a DC elimination filter employed in the first embodiment.

FIG. 7 is a block diagram showing an example specific configuration of the same DC elimination filter

FIG. 8 is a block diagram showing the configuration of a period detector employed in the first embodiment.

FIG. 9 is a flowchart showing the details of a process that is executed by the same period detector.

FIG. 10 is a waveform diagram for description of the details of processing that is performed by the same period detector.

FIG. 11 is a waveform diagram showing an example operation of the same period detector.

FIGS. 12A and 12B are waveform diagrams showing an example sound signal that is prone to cause erroneous estimation of a fundamental frequency.

FIG. 13 is a diagram illustrating the details of processing that is performed by a selector employed in the first embodiment.

FIG. 14 is a graph showing a nonlinear function that is used by the same selector.

FIGS. 15A to 15C are waveform diagrams illustrating an example operation of the same selector.

FIGS. 16A and 16B are waveform diagrams illustrating an example of signal processing that utilizes pitch marks.

FIGS. 17A to 17E are waveform diagrams illustrating a conventional pitch marks estimation method.

FIGS. 18A to 18C are waveform diagrams illustrating why matching between pitch marks and a fundamental period is required.

FIG. 19 is a block diagram showing the functional configuration of a signal processing device according to a second embodiment of the disclosure.

FIG. 20 is a waveform diagram illustrating a pitch marks estimation method that is employed in the second embodiment.

FIG. 21 is a waveform diagram illustrating another pitch marks estimation method that is employed in the second embodiment.

FIGS. 22A to 22C are waveform diagrams illustrating advantages of the second embodiment.

FIG. 23 is a block diagram showing the functional configuration of a signal processing device according to the second embodiment that is added with a polarity judging function.

FIG. 24 is a waveform diagram illustrating example processing for positive/negative judgment.

### DETAILED DESCRIPTION OF THE EXEMPLARY EMBODIMENTS

Embodiments of the present disclosure will be hereinafter described with reference to the drawings.

### Embodiment 1

### <Overall Configuration>

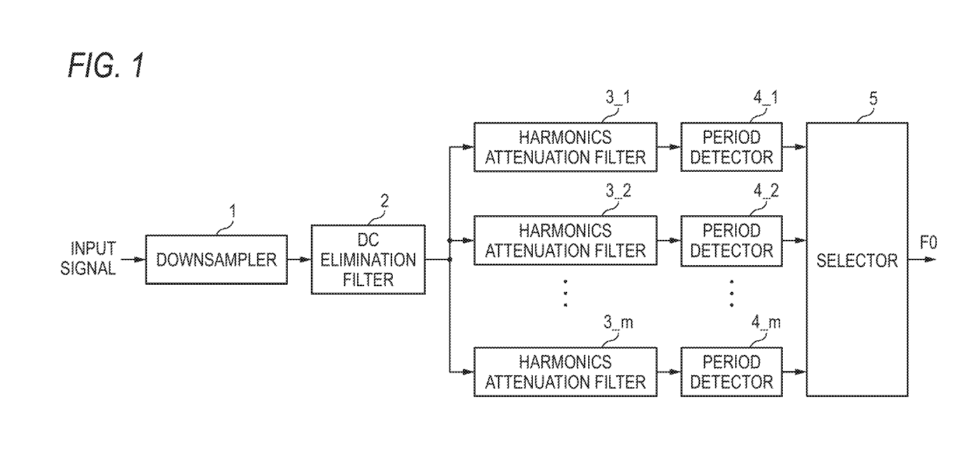

FIG. 1 is a block diagram showing the functional configuration of a signal processing device according to a first embodiment of the disclosure. The signal processing device according to this embodiment is a device for estimating a fundamental frequency of a sound signal. As shown in FIG. 1, the functional configuration of this signal processing device can be divided into a downsampler 1, a DC elimination filter 2, m harmonics attenuation filters 3_1 to 3_m (m: integer that is larger than or equal to 2), m period detectors 4_1 to 4_m, and a selector 5.

The downsampler 1 converts a sound signal sample sequence having a prescribed sampling frequency into a sound signal sample sequence having a lower sampling frequency. The downsampler 1 is provided to reduce the amounts of computation of the DC elimination filter 2 and elements located downstream of the DC elimination filter 2.

The DC elimination filter 2 eliminates DC components from a sound signal sample sequence that is output from the downsampler 1 and outputs a DC-components-eliminated sound signal sample sequence.

The harmonics attenuation filters 3_1 to 3_m are lowpass filters having different cutoff frequencies. The harmonics attenuation filters 3_1 to 3_m are filters that serve to attenuate second and higher harmonic components of a sound signal sample sequence that is output from the DC elimination filter 2 when their frequencies are higher than the cutoff frequencies of the harmonics attenuation filters 3_1 to 3_m.

The period detectors 4_1 to 4_m function as fundamental wave estimators which output pieces of fundamental wave information that are results of estimation about fundamental wave components of input signals to them, respectively. More specifically, by analyzing output signals of the respective harmonics attenuation filters 3_1 to 3_m, the period detectors 4_1 to 4_m output pieces of fundamental wave information about the respective output signals, that is, output pieces of fundamental period information by estimating the fundamental periods of the respective output signals and calculate, and also output pieces of reliability information that are measures indicating to what extents the respective output signals are like a fundamental wave.

The selector 5 selects one of the pieces of fundamental period information (pieces of fundamental wave information) that are output from the respective period detectors 4_1 to 4_m using the pieces of reliability information that are also output from the respective period detectors 4_1 to 4_m, and outputs a fundamental frequency FO which is the reciprocal of the selected fundamental period information.

The signal processing device according to the embodiment has been outlined above. In the embodiment, the individual elements of the signal processing device are improved in various manners to enhance its performance. These improvements will be described below in detail.

<Harmonics Attenuation Filters 3_1 to 3_m>

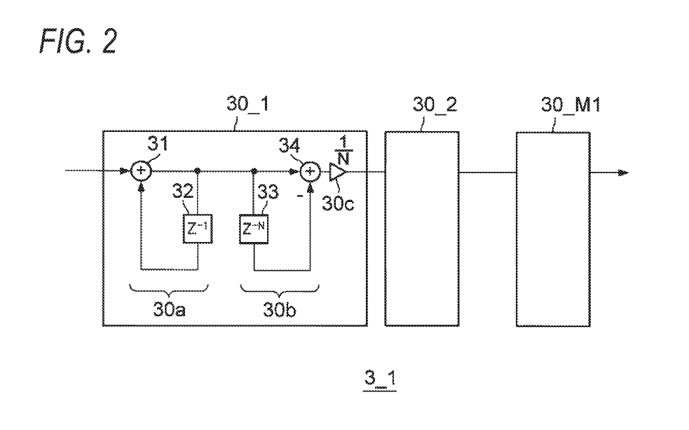

FIG. 2 is a block diagram showing an example configuration of the harmonics attenuation filter 3_1 employed in the embodiment. Although the example configuration of the harmonics attenuation filter 3_1 is shown in FIG. 2, the other harmonics attenuation filters 3_2 to 3_m have the same configuration as the harmonics attenuation filter 3_1.

The harmonics attenuation filter 3_1 is formed by connecting, in cascade, M1 cyclic moving average filters 30_1 to 30_M1 (M1: integer that is larger than or equal to 2) having the same configuration. The cyclic moving average filter 30_1 is a cascade connection of an accumulator 30a which consists of an adder 31 and a delayer 32, a comb filter 30b which consists of a delayer 33 and a subtractor 34, and a shifter 30c.

In the accumulator 30a of the cyclic moving average filter 30_1, the adder 31 adds together a sound signal sample value that is output from the DC elimination filter 2 and a sound signal sample value that is output from the delayer 32, and outputs an addition result. The delayer 32 delays a sound signal sample value that is output from the adder 31 by one sampling period and supplies the delayed sound signal sample value to the adder 31. The accumulator 30a performs accumulation processing of updating the accumulation value by adding a sound signal sample value that is output from the DC elimination filter 2 to a current accumulation value.

In the comb filter 30b, the delayer 33 delays an accumulation value that is output from the accumulator 30a by N sampling periods (N: a power of 2). The subtractor 34 subtracts an output signal value of the delayer 33 from the accumulation value that is output from the accumulator 30a, and outputs a subtraction result.

One sound signal sample value that is output from the DC elimination filter 2 is added to the accumulation value of the accumulator 30a (more specifically, the output signal value of the adder 31) every sampling period. The subtractor 34 subtracts an accumulation value, N sampling periods before, of the accumulator 30a from the accumulation value of the accumulator 30a. Thus, the output signal value of the subtractor 34 becomes equal to the sum of sound signal sampling values that have been output from the DC elimination filter 2 for N sampling periods by the present time.

In the embodiment, the accumulation value of the accumulator 30a may overflow. However, in the embodiment, the signal value to be subjected to the signal processing is expressed in 2's complement form. Thus, even if the accumulation value of the accumulator 30a overflows, the output signal of the comb filter 30b has a normal signal value in the same manner as in a case that the accumulation value does not overflow (i.e., a case that the signal bit width is increased so as to prevent an overflow).

In the embodiment, the number N of delay stages is equal to a power of 2. Thus, the shifter 30c outputs a signal obtained by multiplying the output signal of the comb filter 30b by 1/N by shifting the output signal of the comb filter 30b rightward by log₂ N bits.

In the above-described manner, the cyclic moving average filter 30_1 produces a moving average value, over N sampling periods, of a sound signal sample sequence that is output from the DC elimination filter 2.

The other cyclic moving average filters 30_2 to 30_M1 have the same configuration as the cyclic moving average filter 30_1.

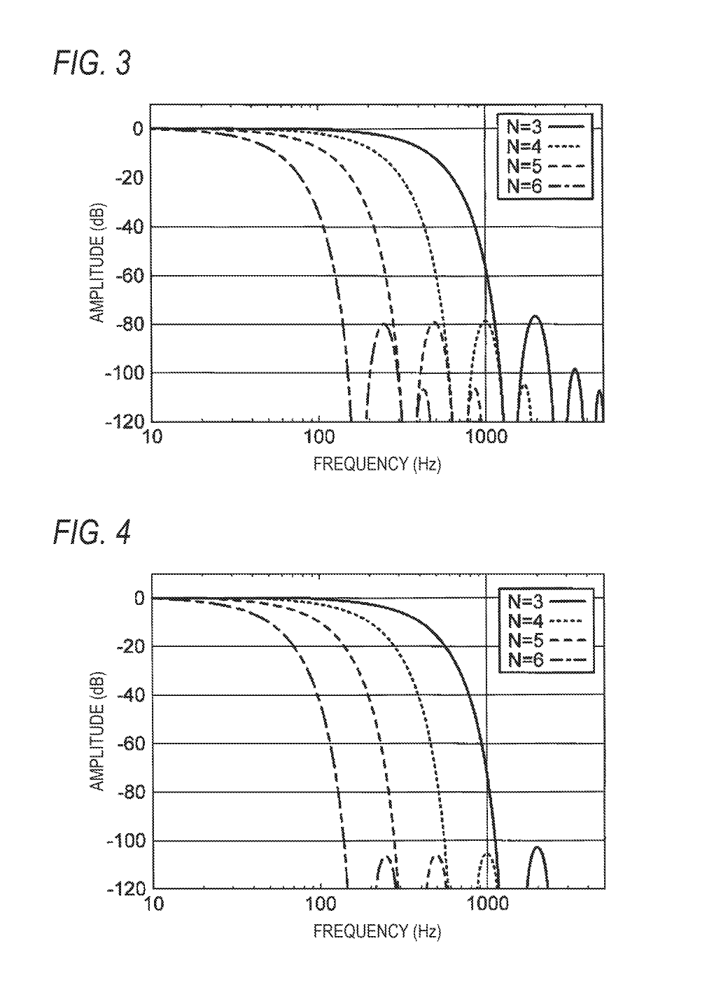

FIGS. 3 and 4 are graphs showing frequency-amplitude characteristics of cyclic moving average filters employed in the embodiment. More specifically, FIG. 3 shows a frequency-amplitude characteristic of a cyclic moving average filter whose number M1 of cascade stages is equal to 6. FIG. 4 shows a frequency-amplitude characteristic of a cyclic moving average filter whose number M1 of cascade stages is equal to 8.

In the frequency-amplitude characteristic of the cyclic moving average filter shown in FIG. 2, a notch (local gain reduction) occurs at a frequency Fs/N where Fs is the sampling frequency of the delayer 33 and N is the number of delay stages of the delayer 33. As the number M1 of cascade stages of the cyclic moving average filter 30_1 to 30_M1 increases, the attenuation around the frequency Fs/N increases and the harmonics attenuation filter comes to function more like a lowpass filter having a cutoff frequency Fs/N. The cutoff frequency of the harmonics attenuation filter is determined by the number of delay stages of the delayer 33 of each of the cyclic moving average filter 30_1 to 30_M1.

In the harmonics attenuation filter, the attenuations of frequency components higher than the cutoff frequency increases as the number M1 of cascade stages of the cyclic moving average filter 30_1 to 30_M1 increases. Where the number M1 of cascade stages of the cyclic moving average filter 30_1 to 30_M1 of the harmonics attenuation filter is set at 6, as shown in FIG. 3 the attenuation of a side lobe is about 80 dB. Where the number M1 of cascade stages of the cyclic moving average filter 30_1 to 30_M1 of the harmonics attenuation filter is set at 8, as shown in FIG. 4 the attenuations of a side lobe is as large as about 100 dB.

As shown in FIGS. 3 and 4, the frequency-amplitude characteristic of the harmonics attenuation filter employed in the embodiment has a gentle shoulder characteristic.

If a harmonics attenuation filter having a steep shoulder characteristic were employed, in the case where the pass band includes not only the fundamental frequency of an input signal but also frequencies of a certain part of higher harmonics, a signal including those higher harmonic components with high intensities would be output from the harmonics attenuation filter and hence it would become difficult to estimate a fundamental frequency correctly from the output signal of the harmonics attenuation filter.

In contrast, in the embodiment, the harmonics attenuation filter is used which exhibits a frequency-amplitude characteristic having a gentle shoulder characteristic as shown in FIGS. 3 and 4. Thus, higher harmonic components of an input signal are attenuated to proper degrees. Since the frequency-amplitude characteristic of the harmonics attenuation filter has a gentle shoulder characteristic, the attenuations it causes in higher harmonic components of an input signal may be small. However, since the shoulder characteristic of the frequency-amplitude characteristic of the harmonics attenuation filter is such that the attenuation of an input signal increases as the frequency becomes higher, higher harmonic components of the input signal are attenuated more than its fundamental wave component. As a result, having smaller higher harmonic components than the input signal, an output signal of the harmonics attenuation filter becomes similar in waveform to a fundamental wave. This makes easier processing of estimating a fundamental period from the output signal of the harmonics attenuation filter.

In the harmonics attenuation filter employed in the embodiment, by setting the number N of delay stages of the delayer 33 of each comb filter 30b at a power of 2, processing that is equivalent to multiplication by 1/N is realized by the shifter 30c which performs a rightward shift of log₂ N bits. As a result, the amount of computation of each harmonics attenuation filter of the signal processing device can be reduced remarkably and thus a harmonics attenuation filter capable of high-speed operation can be realized.

### <Downsampler 1>

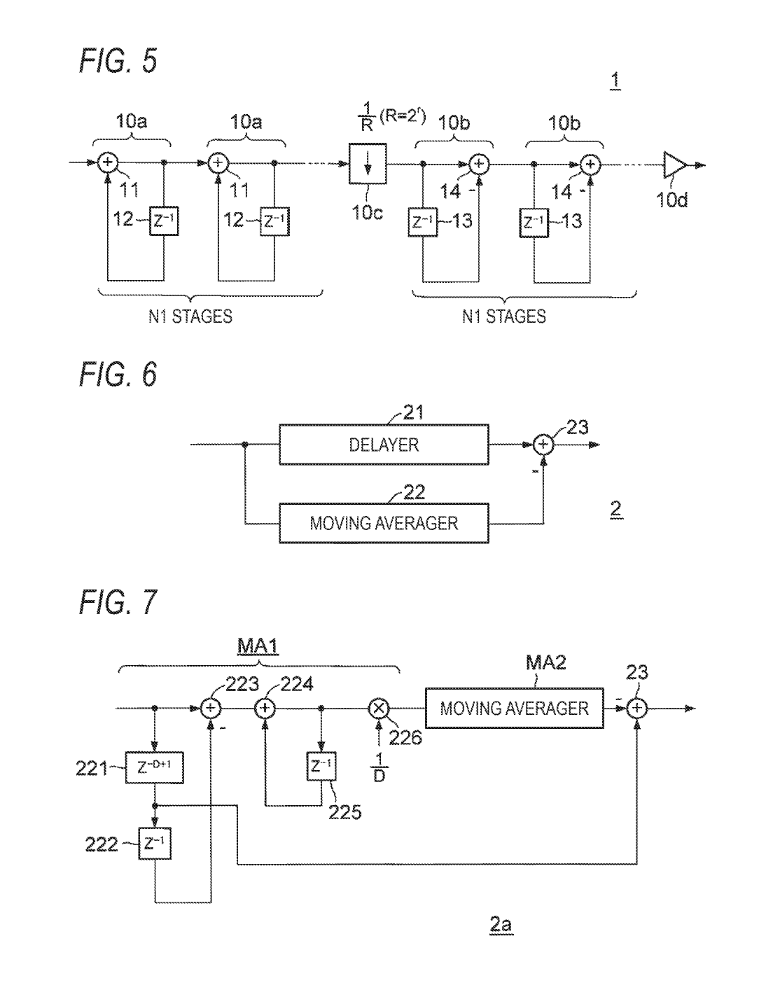

FIG. 5 is a block diagram showing an example configuration of the downsampler 1 employed in the embodiment. As described above, the downsampler 1 is used for reducing the amount of computation of each of the DC elimination filter 2 and elements located downstream of the DC elimination filter 2. The embodiment employs, as the downsampler 1, a high-speed downsampler that exhibits a linear phase characteristic.

As shown in FIG. 5, the downsampler 1 is formed by connecting, in cascade, a cascade connection of N1 stages (N1: integer that is a power of 2) of accumulators 10a each of which consists of an adder 11 and a delayer 12, a decimator 10c, a cascade connection of N1 stages of comb filters 10b each of which consists of a delayer 13 and a subtractor 14, and a shifter 10d.

The downsampler 1 is such that a downsampling function is added to the harmonics attenuation filter 3_1 shown in FIG. 2. More specifically, the downsampler 1 is obtained by subjecting the harmonics attenuation filter 3_1 shown in FIG. 2 to the following changes:

a. The M1 accumulators 30a of the cyclic moving average filters 30_1 to 30_M1 shown in FIG. 2 are moved together to the front-stage side and the M1 comb filters 30b of the cyclic moving average filters 30_1 to 30_M1 are moved together to the rear-stage side.

b. The decimator 10c is disposed between the front-stage-side M1 accumulators 30a and the rear-stage-side M1 comb filters 30b.

c. The number of delay stages of the delayer 33 of each comb filter 30b is changed to 1.

In the harmonics attenuation filter 3_1 shown in FIG. 2, the accumulators 30a and the comb filters 30b are linear elements. Thus, the function of the harmonics attenuation filter 3_1 does not change even if their positions are changed. Thus, referring to FIG. 5, the part consisting of the N1 stages of accumulators 10a, the N1 stages of comb filters 10b, and the shifter 10d functions as a lowpass filter like the cyclic moving average filters 30_1 to 30_M1 shown in FIG. 2 do.

The decimator 10c performs decimation processing of passing one input sample per R=2^{r} input samples (r: integer). The delayer 13 of each comb filter 10b operates with a sampling period that is equal to the period in which one sample passes through the decimator 10c. The delayer 33 of each comb filter 30b shown in FIG. 2 operates with the same sampling period as the delayer 32 of the immediately upstream accumulator 30a. Thus, to cause the cyclic moving average filter 30_1 to calculate a moving average over N sampling periods, the delayer 33 of the comb filter 30b needs to be an N-stage delayer. In contrast, in the downsampler 1 shown in FIG. 5, the delayer 13 of each comb filter 10b operates with the sampling period that is R times that of the delayer 12 of each accumulator 10a. Thus, in the downsampler 1 shown in FIG. 5, it suffices that the number of stages of the delayer 13 of each comb filter 10b be equal to 1. As a result, in the downsampler 1, the memory capacity to realize each delayer 13 can be reduced.

### <DC Elimination Filter 2>

FIG. 6 is a block diagram showing an example configuration of the DC elimination filter 2 employed in the embodiment. The DC elimination filter 2 is equipped with a delayer 21 and a moving averager 22 to which an output signal of the downsampler 1 is input and a subtractor 23 which subtracts an output signal of the moving averager 22 from an output signal of the delayer 21 and outputs a resulting DC-component-eliminated signal. The moving averager 22 is a circuit for calculating a moving average, over D sampling periods (D: prescribed integer), of an input sample sequence.

FIG. 7 is a block diagram showing the configuration of a DC elimination filter 2a which is a specific version of the DC elimination filter 2 shown in FIG. 6. The DC elimination filter 2a consists of moving averagers MA1 and MA2 and a subtractor 23. In the DC elimination filter 2a, part of the moving averager MA1 plays the role of the delayer 21 shown in FIG. 6.

As shown in FIG. 7, an output signal of the upstream downsampler 1 is input to a subtractor 223 after passing through, in order, a delayer 221 whose number of delay stages is equal to D−1 and a delayer 222 whose number of delay stages is equal to 1. The subtractor 223 subtracts, from the output signal of the upstream downsampler 1, an output signal of the delayer 222, that is, a signal obtained by delaying the output signal of the downsampler 1 by D sampling periods, and outputs a resulting signal. An accumulator that consists of an adder 224 and a delayer 225 accumulates output signals of the subtractor 223. A multiplier 226 multiplies an output signal of the accumulator by a coefficient 1/D. As a result, a moving average, over D sampling periods, of a sample sequence that is input from the downsampler 1 is output from the multiplier 226. Where the number D of delay stages is a power of 2, the multiplier 226 may be replaced by a shifter that performs a rightward shift of log₂ N bits.

The moving averager MA2 have basically the same configuration as the moving averager MA1. A subtractor 23 subtracts an output signal of the moving averager MA2 from a signal that is obtained by delaying the output signal of the downsampler 1 by (D−1) sampling periods, and thereby outputs a DC-component-eliminated signal.

<Period Detectors 4_1 to 4_m>

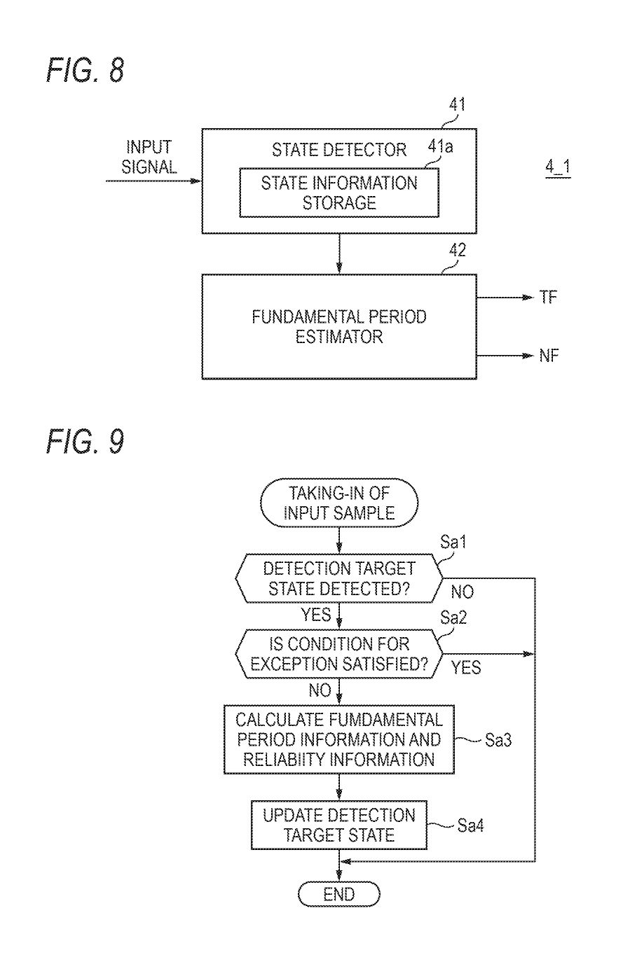

The embodiment employs the period detectors 4_1 to 4_m which are robust to a fundamental period estimation error due to harmonic components. FIG. 8 is a block diagram showing the functional configuration of the period detector 4_1 as a representative one. The other period detectors 4_2 to 4_m have the same configuration as the period detector 4_1.

As shown in FIG. 8, the period detector 4_1 is equipped with a state detector 41 and a fundamental period estimator 42. The state detector 41 includes a state information storage 41a.

An output signal of the upstream harmonics attenuation filter 3_1 is given to the state detector 41 as an input signal. The state detector 41 detects, while selecting a detection target state from plural kinds of states of the input signal in prescribed order, detection the target state from the input signal.

More specifically, the state detector 41 detects states of an input signal repeatedly on the assumption that a state STa that the input signal crosses the zero level toward the positive side, a state STb that the input signal has a positive peak, a state STc that the input signal crosses the zero level toward the negative side, and a state STd that the input signal has a negative peak occur repeatedly in order of STa STb→STc→STd→STa→ . . . .

Stated in more detail, after detecting occurrence of, for example, the state STa in the input signal, the state detector 41 changes the detection target to the state STb and waits for occurrence of the state STb in the input signal disregarding occurrence of the other states STa, STc, and STd. After detecting occurrence of the state STb in the input signal, the state detector 41 changes the detection target to the state STc and waits for occurrence of the state STc in the input signal disregarding occurrence of the other states STa, STb, and STd. Operating likewise thereafter, the state detector 41 selects a detection target state in the prescribed order, that is, in order of STd→STa→STb→STc→STd→ . . . , and detects the selected detection state from the input signal.

The above-described manner of detection of a state of an input signal by the state detector 41 has exceptions. That is, even if a state selected according to the prescribed order is detected in the input signal, this state is excluded from the detection targets if a prescribed condition is satisfied.

More specifically, even if the current detection target is the state STd (negative peak) and the period detector 4_1 has detected a negative peak in an input signal, the period detector 4_1 considers as if to have not detected the negative peak if the absolute value of the amplitude of the detected negative peak is extremely smaller than that of a positive peak detected immediately before. Likewise, even if the current detection target is the state STb (positive peak) and the period detector 4_1 has detected a positive peak in an input signal, the period detector 4_1 considers as if to have not detected the positive peak if the absolute value of the amplitude of the detected positive peak is extremely smaller than that of a negative peak detected immediately before.

These exceptions are made on the assumption that a fundamental wave of a sound signal seldom has a waveform in which the absolute value of the amplitude of a peak is extremely smaller than that of an immediately preceding peak. To perform the above exclusion processing, the state detector 41 is equipped with the state information storage 41a which holds pieces of state information each indicating the type of a state STa, STb, STc, or STd detected by the state detector 41, a detection time, and a detected amplitude value.

Various methods for judging whether the absolute value of the amplitude of a detected peak is extremely smaller than that of an immediately preceding peak are conceivable. For example, a proper threshold value th is set and it is judged that the absolute value of the amplitude of a detected peak is extremely smaller than that of an immediately preceding peak if the ratio r of the absolute value of the amplitude of the detected peak with respect to that of the immediately preceding peak is smaller than the threshold value th.

The fundamental period estimator 42 estimates fundamental period information TF of an input signal based on times at which the states STa, STb, STc, and STd were detected by the state detector 41. In addition to estimating and outputting fundamental period information TF of an input signal, the fundamental period estimator 42 employed in the embodiment calculates reliability information NF indicating to what extent the waveform of the input signal is like a fundamental wave and outputs it.

FIG. 9 is a flowchart showing the details of a process that is executed by the period detector 4_1. Every time the period detector 4_1 takes in a sample of an input signal from the harmonics attenuation filter 3_1, the period detector 4_1 executes the process shown in FIG. 9. In FIG. 9, steps Sa1, Sa2, and Sa4 are steps executed by the state detector 41 and step Sa3 is a step executed by the fundamental period estimator 42.

Upon taking in a sample of an input signal from the harmonics attenuation filter 3_1, at step Sa1 the period detector 4_1 judges whether the currently selected detection target state has occurred in an input signal waveform represented by a sample sequence that has been taken in by the present time. More specifically, if the currently selected detection target state is the state STb (positive peak), the period detector 4_1 judges whether a positive peak has appeared in an input signal waveform represented by a sample sequence that has been taken in by the present time. If the judgment result is “no,” the period detector 4_1 finishes the process and waits for supply of a new sample of the input signal from the harmonics attenuation filter 3_1.

On the other hand, if the judgment result at step Sa1 is “yes,” at step Sa2 the period detector 4_1 causes the state information storage 41a to hold state information indicating the type of the state detected at step Sa1, a detection time, and a detected amplitude value and judges whether the detected state satisfies any condition for an exception. More specifically, if the detection target is, for example, a positive peak and a positive peak is detected at step Sa1, the period detector 4_1 refers to the state information storage 41a and judges whether the ratio of the absolute value of the amplitude of the detected positive peak with respect to that of an immediately preceding negative peak is smaller than a prescribed threshold value. If the judgment result is “yes,” the period detector 4_1 finishes the process and waits for supply of a new sample of the input signal from the harmonics attenuation filter 3_1.

On the other hand, if the judgment result at step Sa2 is “no,” at step Sa3 the period detector 4_1 adds, to the state information of the state that was subjected to the judgment at step Sa2, information to the effect that it does not satisfy any condition for exception. And the period detector 4_1 refers to the state information storage 41a and calculates fundamental period information and reliability information.

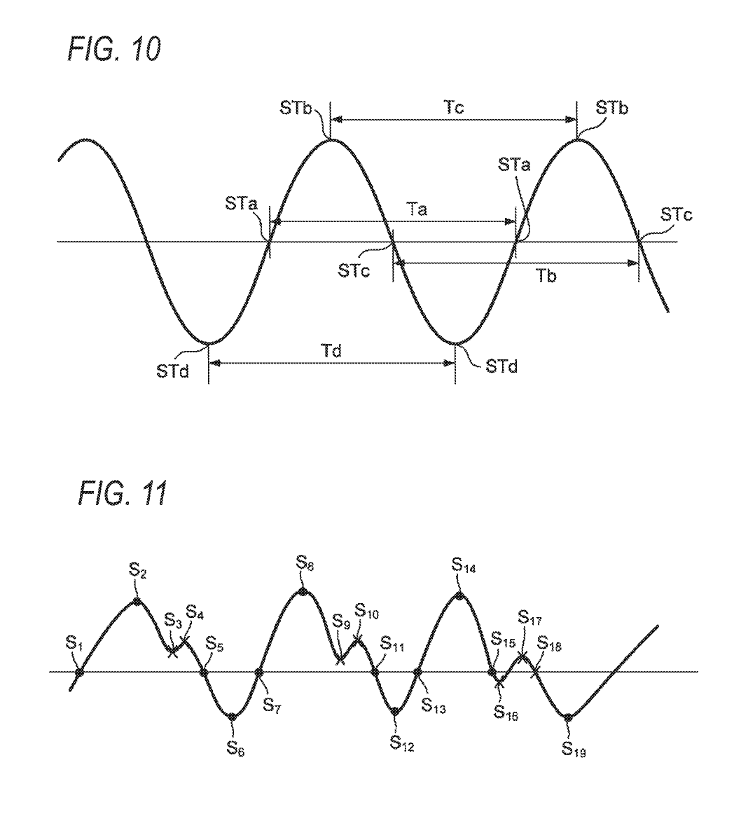

A process for calculating fundamental period information and reliability information that is executed by the period detector 4_1 will now be described with reference to FIG. 10. FIG. 10 shows an input signal waveform that is represented by a sample sequence that is taken in by the period detector 4_1.

For example, if the rightmost state STc in FIG. 10 is detected at step Sa1 and the process moves to step Sa3 via step Sa2, the fundamental period estimator 42 of the period detector 4_1 refers to the state information storage 41a and determines detection times of the states in about 2.5 periods of the input signal to the time of the current state STc, that is, detection times of the states STd, STa, STb, STc, STd, STa, STb, and STc that are arranged in this order rightward in FIG. 10.

Using the thus-determined times, the period detector 4_1 calculates an interval Ta between adjacent positive-going zero-cross time points, an interval Tb between adjacent negative-going zero-cross time points, an interval Tc between adjacent positive peaks, and an interval Td between adjacent negative peaks. Then the period detector 4_1 calculates fundamental period information TF of the input signal according to the following Equation (1):

[Formula 1]

TF=(Ta+Tb+Tc+Td)/4 (1)

And the period detector 4_1 calculates reliability information NF indicating to what extent the input signal waveform is like a fundamental wave (indicating a likelihood of a fundamental wave of the input signal) according to the following Equation (2):

[Formula 2]

NF=(|Ta−TF|+|Tb−TF|+|Tc−TF|+|Td−TF|)/TF (2)

Equation (2) is just an example; it suffices that the fundamental period information TF be able to represent a variation of the intervals Ta, Tb, Tc, and Td.

When calculating the fundamental period information TF and the reliability information NF, the fundamental period estimator 42 of the period detector 4_1 holds the calculation results, that is, the fundamental period information TF and the reliability information NF, in an output register. The selector 5 which is disposed downstream of the period detector 4_1 takes in the fundamental period information TF and the reliability information NF from the output register and uses them in calculation processing for estimation of a fundamental frequency.

Upon completion of step Sa3, at step Sa4 the state detector 41 of the period detector 4_1 updates the detection target state. More specifically, the state detector 41 changes the detection target state to the state STb, STc, STd, or STa if the current detection target state is the state STa, STb, STc, or STd. Then the period detector 4_1 finishes the process and waits for supply of a new sample of the input signal.

The details of the process that is executed by the period detector 4_1 have been described above.

FIG. 11 is a waveform diagram showing an example operation of the period detector 4_1, that is, an input signal waveform that is represented by a sample sequence that is taken in by the period detector 4_1 from the harmonics attenuation filter 3_1. In this example, each of points S₁-S₁₉ corresponds to one of the states STa-STd. Among points S₁-S₁₉, ones indicated by a black circle are points that are used for calculation of fundamental period information TF and reliability information NF because the judgment results at steps Sa1 and Sa2 in FIG. 9 are “yes” and “no,” respectively. Among points S₁-S₁₉, ones indicated by a “x” mark are points that are not used for calculation of fundamental period information TF and reliability information NF because the judgment result at step Sa1 is “no” or the judgment result at step Sa2 in FIG. 9 is “yes.”

For example, although point S₃ corresponds to the state STd (negative peak), it is not judged a detection target state at step Sa1 because it is detected without detection of the state STc (negative-going zero-cross time point) after detection of point S₂ which corresponds to the state STb (positive peak). Although point S₄ corresponds to the state STb (positive peak), it is not judged a detection target state at step Sa1 because it is detected without detection of the state STa (positive-going zero-cross time point). Points S₉ and S₁₀ are not judged a detection target state either, like points S₃ and S₄.

Although point S₁₉ corresponds to the state STd (negative peak), the absolute value at point S₁₆ is far different from that at point S₁₄. Thus, for point S₁₆, the judgment result at step Sa2 becomes “yes” and hence this state is not considered a detection target.

The states at points S₁₇ and S₁₈ are not considered a detection target at step Sa1 because they are not the detection target state STd (negative peak).

Although the period detector 4_1 has been described above as an example, the other period detectors 4_2 to 4_m perform the same processing as the period detector 4_1.

According to the period detectors 4_1 to 4_m, as described above, fundamental period information TF and reliability information NF can be calculated by detecting various states of an input signal while states that do not appear according to the prescribed order and states that prevent the input signal from being like a fundamental wave such as peaks that are extremely smaller in absolute value than an immediately preceding peak are excluded from the detection targets. As a result, fundamental period information can be estimated correctly even in a situation that it is difficult to estimate fundamental period information because an input signal contains harmonic components.

### <Selector 5>

The selector 5 takes in pieces of fundamental period information TF and pieces of reliability information NF from the output registers of the period detectors 4_1 to 4_m, respectively, at a prescribed frame rate (e.g., one frame time is equal to several tens of sampling periods) and performs computation processing for estimation of a fundamental frequency. To obtain a final fundamental frequency estimation result at a certain time point, it is basically appropriate to select one, outputting smallest reliability information NF at that time point, of the period detectors 4_1 to 4_m (i.e., a period detector that has estimated a fundamental period based on an input signal that is like a fundamental wave to a largest extent) and calculate a fundamental frequency F0 based on fundamental period information TF that is output from that period detector.

However, there may occur an event that one of the period detectors 4_1 to 4_m erroneously judges that a higher harmonic contained in an input signal is a fundamental wave and employs the period of that higher harmonic as a fundamental period. This event may result in a situation that the extent to which this input signal is like a fundamental wave (erroneous judgment) is so large (i.e., reliability information NF that is calculated according to Equation (2) using fundamental period information TF calculated according to Equation (1) is so small) as to exceed the extents to which input signals of the other period detectors are like a fundamental wave. In this case, the estimation of a fundamental frequency is rendered in error.

One measure for preventing such erroneous estimation of a fundamental frequency is a fundamental frequency estimation method that is based on dynamic programming. More specifically, fundamental period information TF estimation results are selected so that temporal continuity is maintained. However, this method has a problem that it is prone to cause erroneous estimation of a fundamental frequency contrary to the intention in the case where the period detectors 4_1 to 4_m are given input signals of a sound that contains many subharmonics or noise.

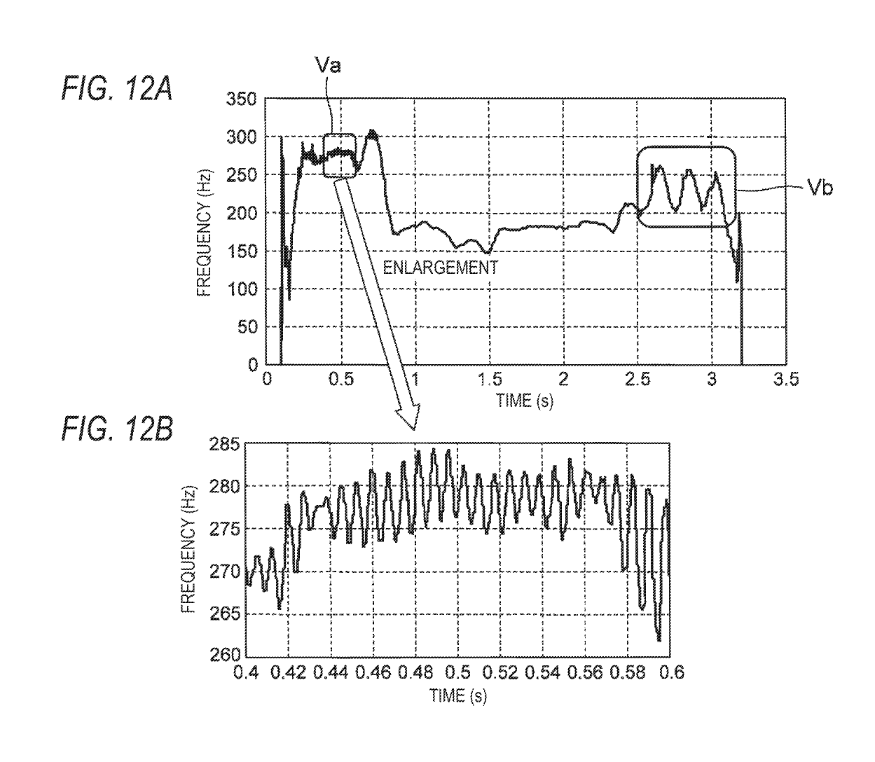

FIGS. 12A and 12B show an example sound signal that is prone to cause erroneous estimation of a fundamental frequency. In FIGS. 12A and 12B, the horizontal axis represents time and the vertical axis represents the frequency of a sound signal. The sound signal is frequency-modulated in regions Va and Vb shown in FIG. 12A. In the region Va, the sound signal is frequency-modulated by growling at about 135 Hz. In the region Vb, the sound signal is frequency-modulated by vibrato at about 5 Hz. FIG. 12B is an enlarged graph of the region Va of FIG. 12A. When such a frequency-modulated sound signal, in particular, a sound signal that is frequency-modulated at a high modulation frequency as in the case of growling, is given as an input sound signal, erroneous estimation of a fundamental frequency due to erroneous selection of a fundamental period is prone to occur in the selector 5.

In view of the above, in the embodiment, the selector 5 which determines a final fundamental frequency F0 based on pieces of fundamental period information TF that are estimation results of the period detectors 4_1 to 4_m, respectively, is made one that utilizes a nonlinear cost function. The selector 5 employed in the embodiment will be described below in detail.

In the embodiment, the selector 5 calculates a fundamental frequency F0 by calculating a value of a cost function that includes both of a cost function relating to the extent to which an input signal waveform processed by each of the period detectors 4_1 to 4_m is a likelihood of a fundamental wave (i.e., the degree of certainty that an estimated fundamental period is equal to the fundamental frequency of the input signal) and a nonlinear cost function relating to temporal continuity between fundamental periods and selecting fundamental period information TFₖ that is output from a period detector 4_k that provides a minimum value of that cost function.

More specifically, in each frame i, every time the selector 5 receives pieces of fundamental period information TF_{i,j} and pieces of reliability information NF_{i,j} (j=1 to m) from the respective period detectors 4_1 to 4_m, the selector 5 calculates a cost function value D_{i,j} according to the following Equation (3):

$$\begin{matrix}[ Formula 3 ] & \\ {D}_{i , j} = {d}_{i , j} + {min}_{k ∈ {I}_{i - 1}} \{ {D}_{i - 1 , k} + {δ}_{i , j , k} \} \\ 1 \leq j \leq {I}_{i} & ( 3 )\end{matrix}$$

In Equation (3), D_{i, j} represents the cost function value for selection of fundamental period information TF_{i,j} that is output from the period detector 4_j (j=1 to m) in frame i, for the purpose of calculating a fundamental frequency F0. Parameter D_{i-1,k} is the cost function value that was used for selection of fundamental period information TF_{i-1,k} that was output from a period detector 4_k in frame i−1 that precedes frame i by one frame. Parameter d_{i,j} represents the cost function value that is based on an extent to which an input signal waveform used for calculation of the fundamental period information TF_{i,j} in frame i is like a fundamental wave. Parameter δ_{i,j,k} represents the cost function value relating to temporal continuity between fundamental periods in selecting the fundamental period information TF_{i,j} of the period detector 4_j in frame i.

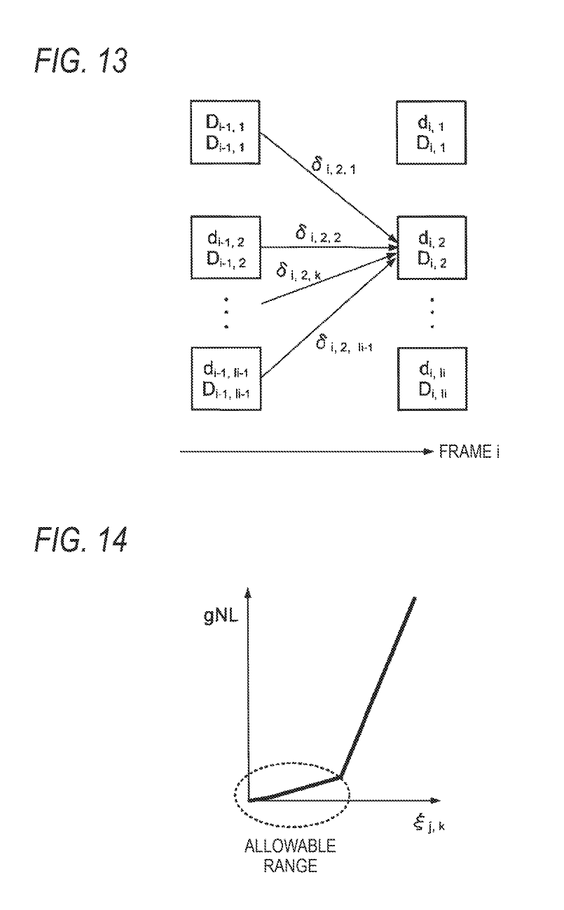

FIG. 13 is a diagram schematically illustrating processing that is performed by the selector 5. FIG. 13 illustrates an example of how a cumulative cost is calculated when the selector 5 selects fundamental period information TF_{i,2} that is second (j=2) hypothetical information relating to the fundamental period in frame i. As shown in FIG. 13, the selector 5 calculates cumulative costs D_{i-1,k}+δ_{i,2,k} for transitions from pieces of kth hypothetical information (k=1 to Iᵢ₋₁) in frame i−1 that precedes frame i by one frame to the second (j=2) hypothetical information in frame i and selects a lowest one of the calculated cumulative costs D_{i-1,k}+δ_{i,2,k}. The selector 5 calculates a cumulative cost D_{i,2} of selection of the fundamental period information TF_{i,2} that is the second (j=2) hypothetical information by adding, to the lowest cumulative cost, a cost function value d_{i, 2} that is based on an extent to which an input signal waveform used for calculation of the second (j=2) hypothetical information in frame i.

The case of j=2 has been described above. The selector 5 calculates cumulative costs D_{i,j} according to Equation (3) for all j's (j=1 to Iᵢ) including j=2, and selects fundamental period information TF_{i,j} whose cumulative cost D_{i,j} is lowest among those cumulative costs D_{i,j}, and outputs its reciprocal as fundamental frequency F0.

The cost function value d_{i,j} that is based on an extent to which an input signal waveform is like a fundamental wave is calculated according to the following Equation (4):

[Formula 4]

d_{i,j}=1−NF_{i,j}·(1ββ·TF_{i,j}) 1≤j≤m (4)

where β is a prescribed constant.

The cost function value δ_{i,j,k} relating to temporal continuity in selecting the fundamental period information TF_{i,j} is calculated according to the following Equation (5):

[Formula 5]

δ_{i,j,k}=FREQ_WT·gNL(ξ_{j,k}) (5)

In Equation (5), FREQ_WT is a prescribed constant. Parameter gNL(ξ_{j,k}) is the value of a nonlinear function of the quantity ξ_{j,k} of a transition from the fundamental period information TF_{i-1,k} to the fundamental period information TF_{i,j}. For example, the transition quantity ξ_{jk,k} is the difference between the logarithm of the fundamental period information TF_{i-1,k} and that of the fundamental period information TF

FIG. 14 is a graph of an example nonlinear function gNL(ξ_{j,k}). As shown in FIG. 14, the value of the nonlinear function gNL(ξ_{j,k}) is very small in an allowable range of the transition quantity ξ_{j,k} between pieces of fundamental period information and increases steeply as the transition quantity ξ_{j,k} increases in a range beyond its allowable range.

The embodiment employs, as the cost function relating to temporal continuity between fundamental periods, the cost function δ_{i,j,k} which includes the above nonlinear function gNL(ξ_{j,k}). Thus, even in a situation that input signals that vary to a large extent in frequency are given to the respective period detectors 4_j (j=1 to m), the cost function δ_{i,j,k} does not increase remarkably as long as the widths of their frequency variations are within an allowable range. As a result, in the embodiment, a fundamental frequency F0 of a sound signal can be estimated correctly by accepting a frequency variation, in an allowable range, of, for example, a sound signal that is frequency-modulated by vibrato or growling while maintaining temporal continuity in selecting fundamental period information TF.

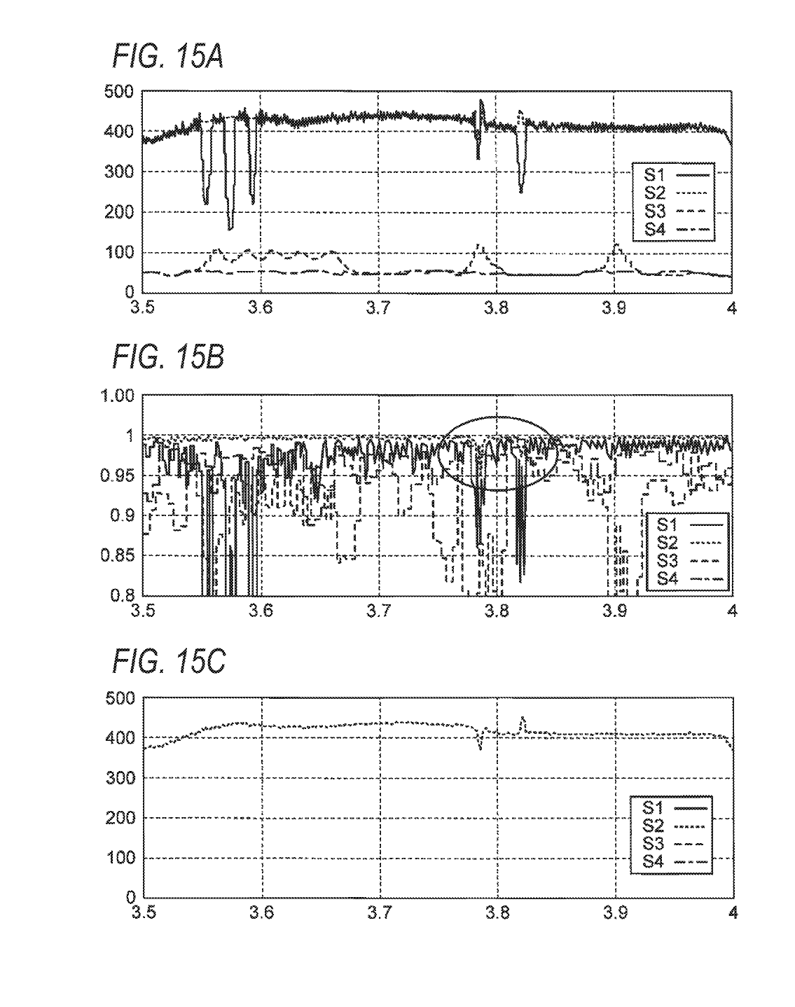

FIGS. 15A-15C illustrate advantages of the embodiment in a case of m=4. In FIGS. 15A-15C, the horizontal axis represents time. In FIGS. 15A and 15C, the vertical axis represents the frequency. In FIG. 15B, the vertical axis represents the reliability information whose value is in a range of 0 to 1.

FIG. 15A shows pieces of fundamental frequency information S1-S4 which are the reciprocals of pieces of fundamental period information TF1-TF4 which are output from the period detectors 4_1 to 4_4, respectively. FIG. 15B shows pieces of reliability information corresponding to the respective pieces of fundamental frequency information S1-S4. FIG. 15C shows the fundamental frequency information S2 which is output finally from the selector 5.

As shown in FIG. 15B, in a circled interval, the reliability information corresponding to the fundamental frequency information S4 dips temporarily and hence the reliability information corresponding to the fundamental frequency information S2 is larger than that corresponding to the fundamental frequency information S4. However, in the embodiment, the fundamental frequency information S2 is output as an estimation result over the entire interval as shown in FIG. 15C because fundamental period information to be used for calculation of a fundamental frequency is selected using the cost function relating to temporal continuity between fundamental periods.

On the other hand, in the embodiment, since the nonlinear cost function δ_{i,j,k} is employed as a function relating to temporal continuity between fundamental periods, a fundamental frequency F0 of a sound signal whose frequency variation is within an allowable range.

### Embodiment 2

Among signal processing techniques for handling a sound signal are ones that utilize pitch marks of, for example, PSOLA (Pitch-Synchronous Overlap-Add) in a sound signal waveform. The pitch mark is a timing-indicative mark that is set in a sound signal every period of its fundamental wave.

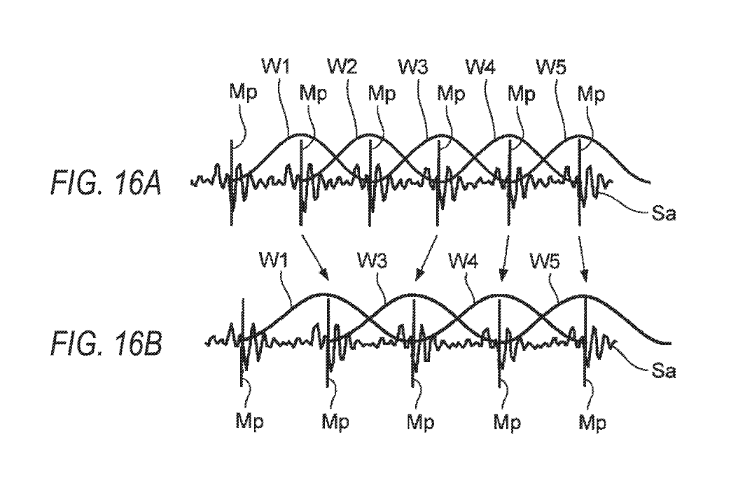

FIGS. 16A and 16B are waveform diagrams illustrating an example of PSOLA-based signal processing. FIG. 16A shows a waveform of a sound signal Sa of plural fundamental periods and pitch marks Mp that are set for the respective fundamental-period intervals. In PSOLA, as shown in FIG. 16A, the sound signal Sa is multiplied by window functions W1-W5 having maximum values at the pitch marks Mp of the fundamental-period intervals, respectively. As shown in FIG. 16B, a manipulation of moving in the time-axis direction and adding together window-function-multiplied sound signals in the respective fundamental-period intervals is then performed. In the state of FIG. 16B, the window-function-W2-multiplied sound signal is omitted and the sound signals as multiplied by the respective window functions W1, W3, W4, and W5 are arranged on the time axis so as to be arranged closer to each other than in FIG. 16A. In the state of FIG. 16B, the pitch of the sound signal Sa is lower than in the original state shown in FIG. 16A.

In the above signal processing using pitch marks, the pitch marks are an important factor that determines the quality of the signal processing. In PSOLA etc., since a sound signal is multiplied by window functions having maximum values at pitch marks, respectively, it is preferable that each pitch mark be set at a position where a feature of the sound tends to appear in a fundamental-period interval of the sound waveform, that is, at a position where waveform change by the multiplication of a window function is not desired. In this sense, it is considered preferable to set pitch marks around GCIs (glottal closure instants).

A technique called SEDREAMS (speech event detection using residual excitation and mean-based signal) which is disclosed in Non-patent document 2 is known as a technique for detecting GCIs. In this technique, GCIs are detected from a sound signal waveform in the following manner.

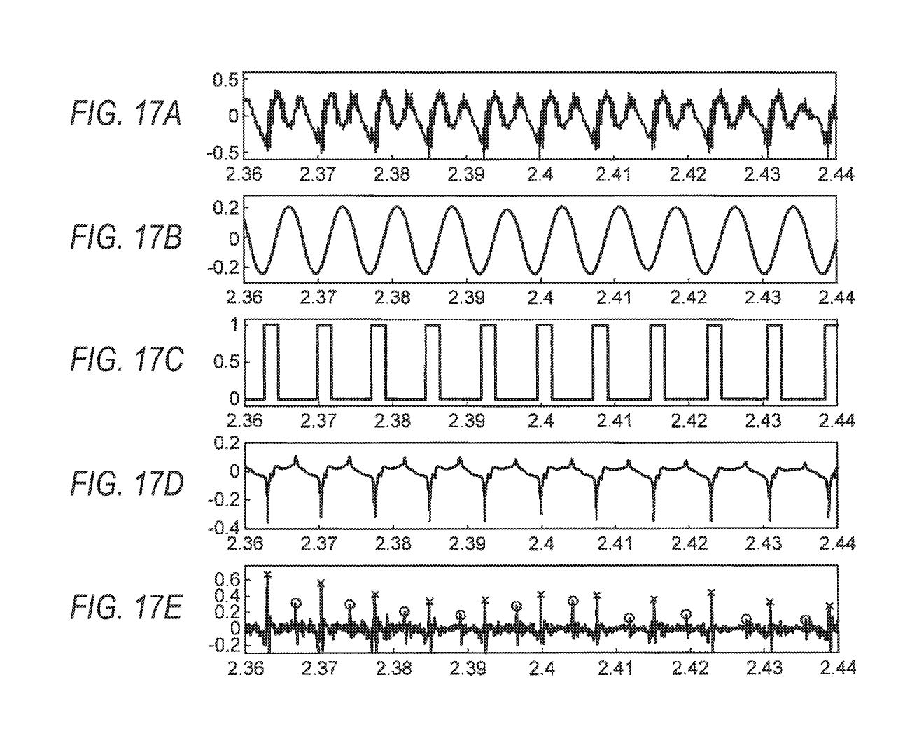

FIG. 17A shows an example processing target sound signal waveform. This sound signal is given to an LPF, whereby a filtered signal is obtained whose frequency band is lower than the fundamental frequency of the sound signal. FIG. 17B shows a waveform of the filtered signal.

A linear predictive residual signal of the sound signal is then generated. FIG. 17E shows a waveform of a linear predictive residual signal. In sound signals, peaks tend to appear around GCIs in a linear predictive residual signal because the amount of information is large there.

Subsequently, referring to FIG. 17B, an interval from a negative peak of the filtered signal to a positive-going zero-cross point is employed as a GCI search interval. FIG. 17C is a waveform showing search intervals which are high-level intervals. Positive peaks existing in the respective search intervals in the linear predictive residual signal are selected as peaks of GCIs, as indicated by marks “x” in FIG. 17E. Positive peaks indicated by marks “∘” are positive peaks that are located outside the search intervals.

In Non-patent document 2, to evaluate the performance of SEDREAMS, negative peak positions of a differential EGG (electroglottograph) signal (see FIG. 17D) that indicates motion of the throat of a person who is uttering a sound of the sound signal shown in FIG. 17A are assumed to be correct positions and are compared with GCIs detected by SEDREAMS. The differential EGG signal is a signal obtained by differentiating an EGG signal that is obtained by an EGG measuring instrument. Comparison between the signals shown in FIGS. 17D and 17E shows that the GCIs (indicated by marks “x” in FIG. 17E) detected by SEDREAMS well coincide with the correct positions (the positions of negative peaks in FIG. 17D).

Incidentally, SEDREAMS has the following problems. First, to obtain the filtered signal shown in FIG. 17B, it is necessary that the fundamental frequency of the processing target sound signal be known in advance. Furthermore, to perform signal processing of PSOLA or the like, the fundamental frequency of the processing target sound signal and pitch marks are used. However, SEDREAMS has a problem that although pitch marks can be obtained, it is not assured that a fundamental frequency that matches the pitch marks is obtained.

SEDREAMS utilizes a linear predictive residual signal of a processing target sound signal, but this is associated with the following problems. First, to generates a linear predictive residual signal, it is necessary to calculate at least an autocorrelation function or an autocovariance function, which poses a problem of a high calculation cost.

In performing a linear predictive analysis on a sound signal, there may occur a case that no clear peaks indicating GCIs appear in a linear predictive residual signal unless an analysis window width and analysis order are set so as to be suitable for the characteristics of a processing target signal.

In a linear predictive residual signal, it is not rare that peaks that originate from consonants or external noise are larger than peaks that originate from vibration of the vocal cords such as peaks of GCIs, in which case it is difficult to detect GCIs.

Furthermore, peaks may not appear in a linear predictive residual signal in the case of a sound signal produced by utterance in which the vocal cords are not closed tightly such as a sound signal produced by soft utterance or a sound signal produced in an unstable period around a start or end of vibration of the vocal cords. In such a case, GCIs cannot be detected.

Still further, SEDREAMS has a problem that matching between the fundamental period of a processing target sound signal and estimated pitch marks is not assured. This problem will be described below.

First, it is desirable that the reciprocal of the interval between pitch marks is in accurate coincidence with the fundamental frequency. However, it is difficult to satisfy this requirement in techniques such as SEDREAMS that are based on detection of peaks. SEDREAMS, in which only selecting one of peaks that appear discretely on the time axis in a linear predictive residual signal is possible, cannot necessarily cope with a fundamental wave frequency transition that is closer to a continuous transition.

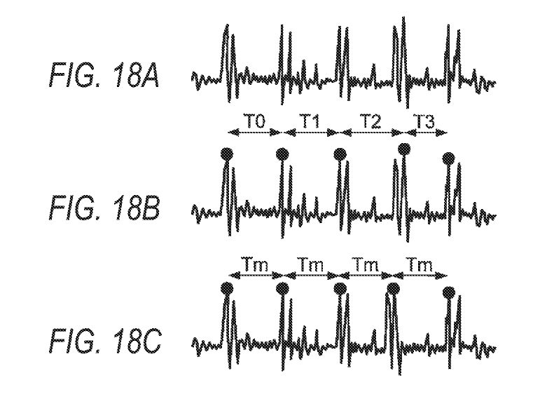

Now assume a sound signal whose fundamental wave frequency is approximately constant. A case occurs frequently that a linear predictive residual signal of such a signal becomes one as shown in FIG. 18A. For example, pitch marks as indicated by black circles in FIG. 18B are obtained when they are detected as peaks of this linear predictive residual signal. Although the fundamental wave frequency of this signal is approximately constant, as shown in FIG. 18B the peak-to-peak interval becomes longer suddenly (an interval T2 which is longer than intervals T0 and T1) or becomes shorter suddenly (interval T3). If this signal is modified so as to have any constant fundamental wave frequency Fm=1/Tm and a new signal is synthesized by the PSOLA method using the above result, a signal shown in FIG. 18C is obtained. Although the manipulation has been performed to obtain pitch marks having a constant interval, the fundamental wave frequency of the resulting waveform is in disorder, that is, it has jitters. Such a synthesized sound is heard so as to include noise that is caused by discontinuity of the fundamental wave frequency.

A second embodiment of the disclosure has been made in the above circumstances, and has an object of providing a signal processing device capable of estimating, stably, at a low calculation cost, pitch marks that match the fundamental frequency of a processing target sound signal.

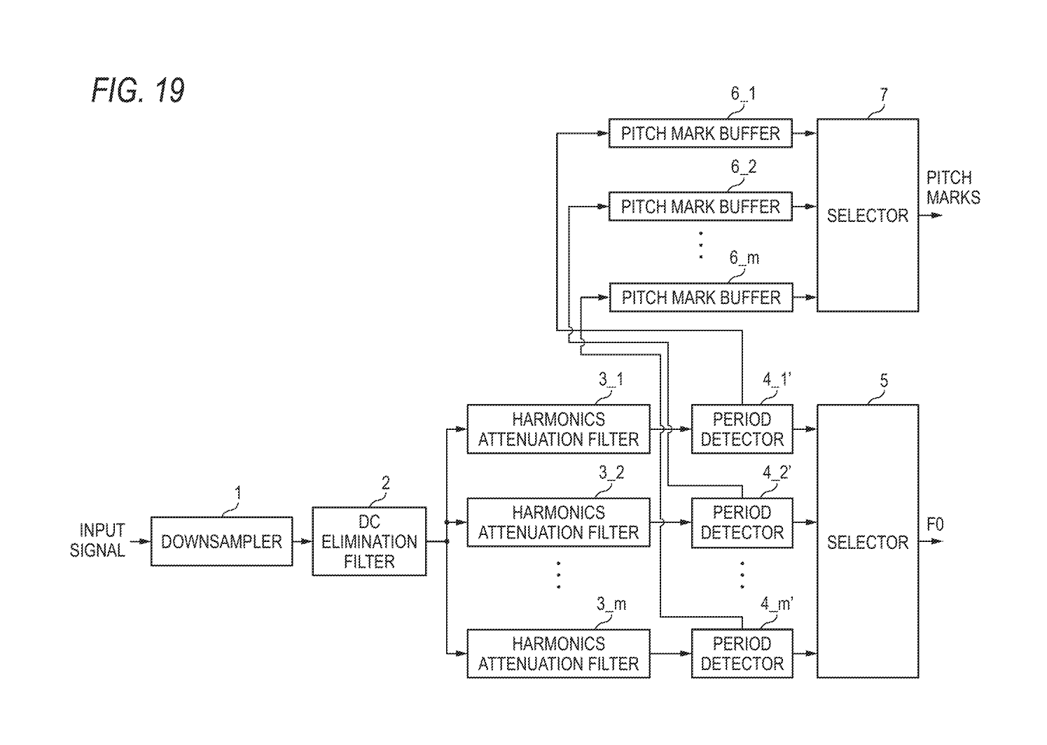

FIG. 19 is a block diagram showing the functional configuration of the signal processing device according to the second embodiment. The signal processing device according to this embodiment is different from that according to the first embodiment (see FIG. 1) in that the period detectors 4_1 to 4_m of the latter are replaced by period detectors 4_1′ to 4_m′ which are added with a pitch marks estimation function. Furthermore, the signal processing device according to this embodiment is additionally equipped with pitch mark buffers 6_1 to 6_m and a selector 7.

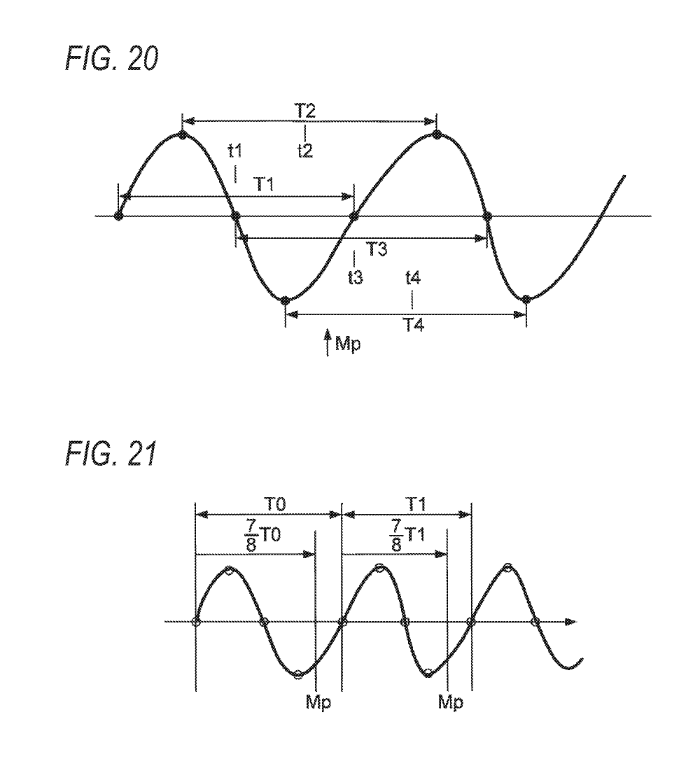

FIG. 20 is a waveform diagram illustrating the details of pitch marks estimation processing that is performed by the period detectors 4_1′ to 4_m′. FIG. 20 shows an example output signal waveform of a harmonics attenuation filter 3_j which is disposed upstream of the period detector 4J′. In this embodiment, the period detector 4_j′ sets a pitch mark at a time point between each negative peak of an output signal waveform of the harmonics attenuation filter 3_j and a positive-going zero-cross point immediately following it.

More specifically, when detecting a rightmost negative peak shown in FIG. 20 in the output signal of the harmonics attenuation filter 3_j, the period detector 4_j′ determines times t1 to t4 shown in FIG. 20. Time t4 is a time that divides, into two equal parts, an interval T4 between the negative peak concerned and a negative peak that precedes it by one period. Time t3 is a time that divides, into two equal parts, an interval T3 between a negative-going zero-cross point that immediately precedes the negative peak concerned and a negative-going zero-cross point that precedes the above negative-going zero-cross point by one period. Time t2 is a time that divides, into two equal parts, an interval T2 between a positive peak that immediately precedes the negative peak concerned and a positive peak that precedes it by one period. Time t1 is a time that divides, into two equal parts, an interval T1 between a positive-going zero-cross point that immediately precedes the negative peak concerned and a positive-going zero-cross point that precedes the above positive-going zero-cross point by one period. The period detector 4_j′ calculates time information of a pitch mark Mp according to the following Equation (6):

$$\begin{matrix}[ Formula 6 ] & \\ Mp = \frac{1}{4} ( t 1 + t 2 + t 3 + t 4 ) & ( 6 )\end{matrix}$$

Where the output signal waveform of the harmonics attenuation filter 3_j is a complete sinusoidal wave, each pitch mark Mp should exist between a negative peak of the output signal waveform of the harmonics attenuation filter 3_j and a positive-going zero-cross point that immediately follows it. The period detector 4_j′ determines times t1 to t4 and calculates a pitch mark Mp according to Equation (6) every time a negative peak appears in the output signal of the harmonics attenuation filter 3_j.

FIG. 21 is a waveform diagram illustrating another example of pitch marks estimation processing that is performed by the period detectors 4_1′ to 4_m′. In this example, every time a positive-going zero-cross point appears in an output signal waveform of the harmonics attenuation filter 3_j, the period detector 4J′ determines a time length 7T/8 that is ⅞ of an interval T between the above positive-going zero-cross point and a positive-going zero-cross point that precedes it by one period and sets a pitch mark Mp at a time point that is later than the latter positive-going zero-cross point by the time length 7T/8.

The period detectors 4_1′ to 4_m′ estimate pitch marks Mp from output signal waveforms of the harmonics attenuation filters 3_j to 3_m, respectively, in the above-described manner, and accumulates pieces of information indicating pitch marks Mp (estimation results) in the pitch mark buffers 6_1 to 6_m. The selector 7 reads out pieces of information indicating pitch marks Mp from the respective pitch mark buffers 6_1 to 6_m, selects one of those pieces of information indicating the pitch marks Mp, and outputs the selected information. The selector 7 performs the selection operation in conjunction with the selection operation of the selector 5. That is, if the selector 5 takes in pieces of fundamental period information TF and pieces of reliability information NF from the respective period detectors 4_1′ to 4_m′ and selects the fundamental period information TF that is output from the period detector 4_j′ from those pieces of fundamental period information TF, the selector 7 selects the information indicating the pitch mark Mp that is output from the period detector 4_j′ and belongs to the interval of the fundamental period indicated by the selected fundamental period information TF and outputs the selected information indicating the pitch mark Mp. As a result, the pitch mark Mp selected by the selector 7 matches the fundamental wave frequency that is output from the selector 5.

The details of the signal processing device according to the second embodiment have been described above.

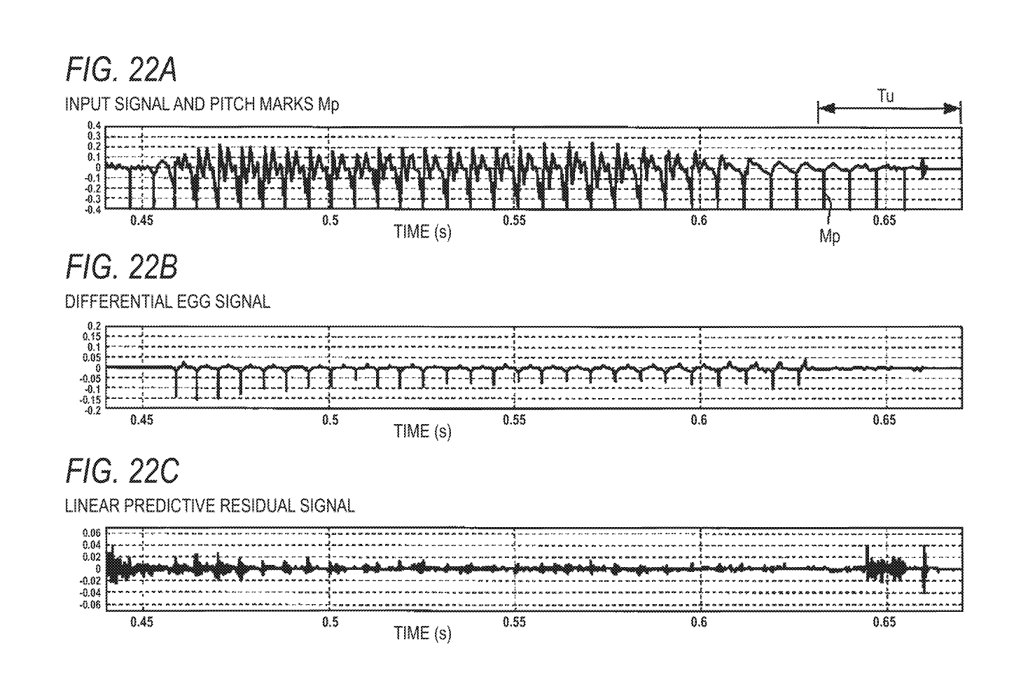

FIGS. 22A-22C illustrate how the signal processing device according to the embodiment operate. In FIGS. 22A-22C, the horizontal axis represents time. FIG. 22A shows an input signal waveform of the signal processing device and pitch marks Mp that are output from the selector 7. FIG. 22B shows a waveform of a differential EGG signal that is acquired from the throat of a person who utters a voice corresponding to the input signal shown in FIG. 22A. FIG. 22C shows a waveform of a linear predictive residual signal that is generated from the input signal shown in FIG. 22A. It is seen from comparison between FIGS. 22A and 22B that the timing of the pitch marks Mp that are estimated in the embodiment well coincide with the timing of generation of negative peaks in the differential EGG signal. It is seen that in the embodiment pitch marks Mp are estimated properly even in an interval Tu when no negative peaks appear in the differential EGG signal. It is also seen that in the embodiment pitch marks Mp are estimated properly even in an interval from time 0.5 sec to 0.64 sec when no clear peaks appear in the linear predictive residual signal.

As described above, in the embodiment, pitch marks that match the fundamental frequency of a processing target sound signal can be estimated stably at a low calculation cost without using a differential EGG signal.

Incidentally, there may occur an event that a polarity-inverted version of a true input signal is input to the signal processing device according to the embodiment, as in, for example, a case that a signal that has been subjected to waveform processing in advance is input to the signal processing device. In such a case, to estimate pitch marks Mp by, for example, the method illustrated by FIG. 20, calculation for estimating pitch marks Mp needs to be performed with timing of occurrence of a positive peak, rather than a negative peak, in an output signal of each harmonics attenuation filter 3_j. In view of this, in a preferable mode, the signal processing device is provided with a function of judging the polarity of an input signal.

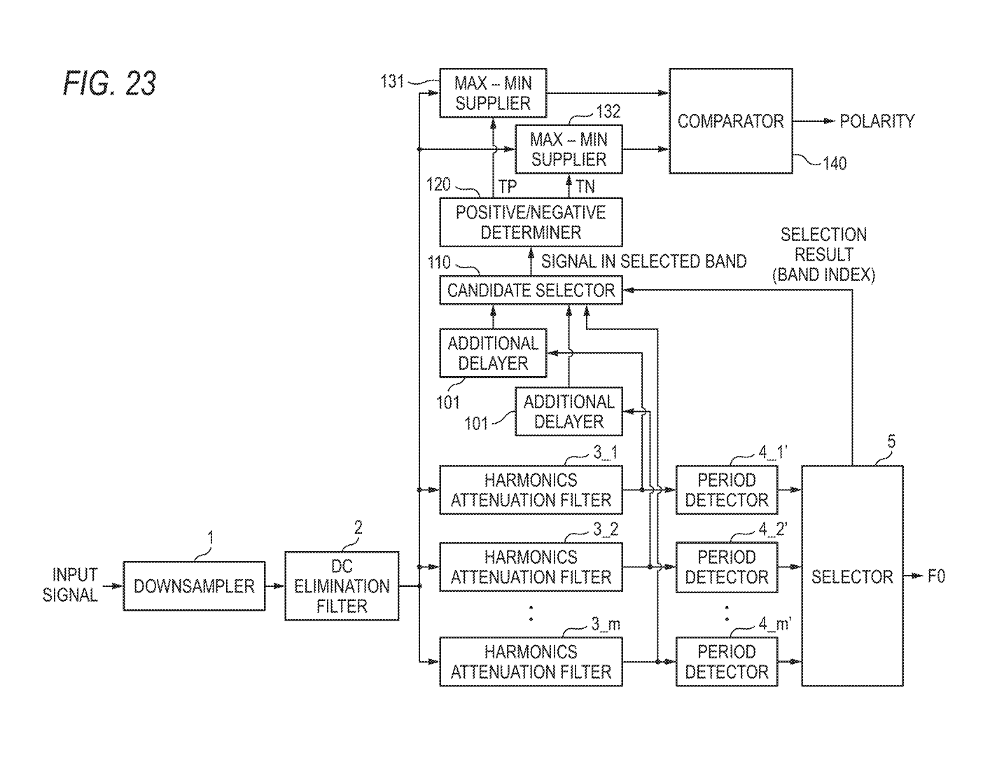

FIG. 23 is a block diagram showing the configuration of a signal processing device that is added with a positive/negative judging function. In FIG. 23, to prevent it from becoming unduly complex, the pitch mark buffers 6_1 to 6_m and the selector 7 which are shown in FIG. 19 are omitted.

In this mode, the polarity of an input signal is judged by checking the amplitude of an original input signal in each of a positive interval and a negative interval of an output signal of each of the harmonics attenuation filters 3_1 to 3_m. This is based on the empirical fact that the amplitude of a sound waveform takes a maximum value and a minimum value in each period around a GCI.

In this signal processing device, when the selector 5 has selected one of fundamental period estimation results that are output from the respective period detectors 4_1′ to 4_m′, the selector 5 supplies a selection result to a candidate selector 110. The selection result is an index j indicating the pass band of the harmonics attenuation filter 3_j that is disposed upstream of the period detector 4_j′ whose fundamental period estimation result has been selected by the selector 5.

Output signals of the harmonics attenuation filters 3_1 to 3_m are supplied to m additional delayers 101, respectively. The additional delayers 101 delay the output signals of the harmonics attenuation filters 3_1 to 3_m and supply delayed output signals to the candidate selector 110. This delay processing is performed to equalize the delays of output signals in other bands to a delay of one, in a band with a largest group delay, of output signals of the harmonics attenuation filters 3_1 to 3_m.

The candidate selector 110 selects one of the output signals, subjected to the delay processing, of the harmonics attenuation filters 3_1 to 3_m according to the selection result supplied from the selector 5, and supplies the selected output signal to a positive/negative determiner 120. More specifically, if the selection result supplied from the selector 5 indicates a harmonics attenuation filter 3_j, the candidate selector 110 selects the output signal of the harmonics attenuation filter 3_j that has been subjected to the delay processing in the associated additional delayer 101 and supplies the selected output signal to the positive/negative determiner 120.

The positive/negative determiner 120 sets a positive polarity signal TP and a negative polarity signal TN at an active level and a non-active level, respectively, while the output signal of the candidate selector 110 is positive, and sets the positive polarity signal TP and the negative polarity signal TN at the non-active level and the active level, respectively, while the output signal of the candidate selector 110 is negative.

A max−min supplier 131 holds the difference max−min between a maximum value max and a minimum value min of an output signal of the DC elimination filter 2 while the positive polarity signal TP is at the active level, and supplies a resulting signal to a comparator 140. A max−min supplier 132 holds the difference max−min between a maximum value max and a minimum value min of an output signal of the DC elimination filter 2 while the negative polarity signal TN is at the active level, and supplies a resulting signal to the comparator 140.

The comparator 140 compares the difference max−min in the positive polarity interval that is supplied from the max−min supplier 131 with the difference max−min in the negative polarity interval that is supplied from the max−min supplier 132. The comparator 140 judges that the input signal has a positive polarity if the difference max−min in the negative-polarity interval is larger than the difference max−min in the positive-polarity interval, and judges that the input signal has a negative polarity if the difference max−min in the positive-polarity interval is larger than the difference max−min in the negative-polarity interval.

The period detectors 4_1′ to 4_m′ perform pitch marks estimation processing according to the judgment result of the comparator 140. For example, where the period detectors 4_1′ to 4_m′ estimate pitch marks by the processing shown in FIG. 20, each of the period detectors 4_1′ to 4_m′ performs calculation processing for pitch mark estimation when a negative peak occurs in an output signal of the associated harmonics attenuation filter 3_j in the case where an input signal has a positive polarity. And each of the period detectors 4_1′ to 4_m′ performs calculation processing for pitch mark estimation when a positive peak occurs in the output signal of the associated harmonics attenuation filter 3_j in the case where the input signal has a negative polarity. Alternatively, instead of switching the calculation processing method for pitch mark estimation, a switching control as to whether to invert the polarity of an output signal of the DC elimination filter 2 may be performed based on the positive/negative judgment result.

The details of the positive/negative judging function of the signal processing device have been described above.

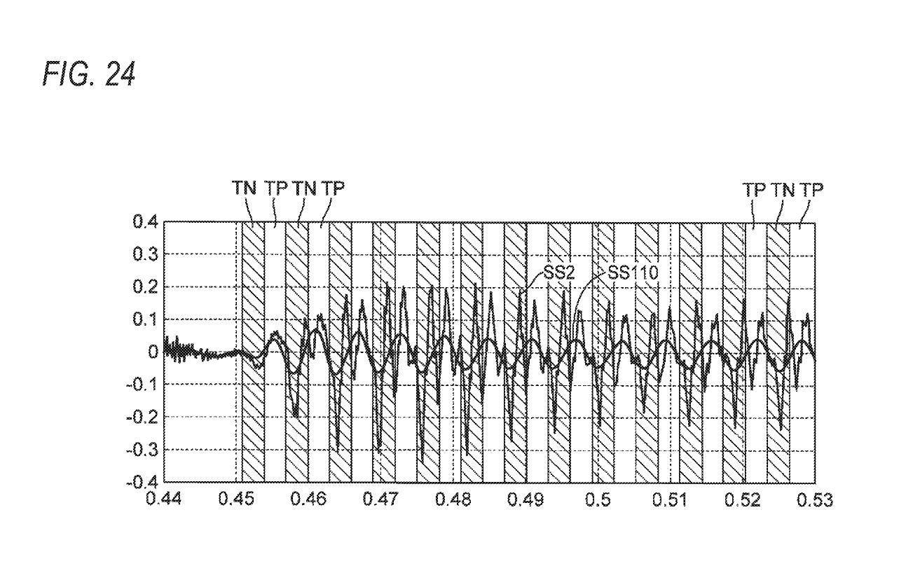

FIG. 24 is a waveform diagram illustrating example processing for positive/negative judgment. In FIG. 24, the horizontal axis represents time and the vertical axis represents the signal value of an output signal SS2 of the DC elimination filter 2 or the signal value of an output signal SS110 of the candidate selector 110. In the example shown in FIG. 24, the difference max−min between a maximum value and a minimum value of the output signal SS2 of the DC elimination filter 2 in an interval TN in which the output signal SS110 of the candidate selector 110 is negative is larger than that in an interval TP in which the output signal SS110 of the candidate selector 110 is positive. Thus, the comparator 140 judges that the input signal has a positive polarity.

It is preferable that a positive/negative judgment be performed for several periods of the signal SS2 and a final positive/negative judgment be made by majority decision, for the following reasons. First, vibration of the vocal cords is unstable in first several periods after a start of utterance. Second, a sound signal of a vowel is left with influence of a consonant (in particular, plosive). Third, a positive/negative judgment may err due to, for example, mixing of noise.

If the positive/negative judgment changes, as described above the calculation processing method for pitch mark estimation is switched or the polarity of the output signal of the DC elimination filter 2 is reversed. However, it is not preferable that switching of the calculation processing method for pitch mark estimation or reversal of the polarity of the output signal of the DC elimination filter 2 is made halfway during a voiced section. In preferred modes, the positive/negative judgment timing is controlled by one of the following processes.

Process a: The selector 5 is caused to judge whether a processing target sound signal is in a voiced section or an unvoiced section. A positive/negative judgment is made using a first several-period portion of a section that is first judged as a voiced section, and a result of this positive/negative judgment is used thereafter. That is, if necessary, the calculation processing method for pitch mark estimation is switched or the polarity of the output signal of the DC elimination filter 2 is reversed according to this positive/negative judgment result. Whether the sound signal is in a voiced section or an unvoiced section may be judged based on, for example, reliability information indicating to what extent fundamental period information selected by the selector 5 is like the period of a fundamental wave.

Process b: The selector 5 is caused to judge, continuously, whether a processing target sound signal is in a voiced section or an unvoiced section. Every time a processing target sound signal is judged to be in a voiced section, a positive/negative judgment is made using a first several-period portion of the voiced section and, if necessary, the calculation processing method for pitch mark estimation is switched or the polarity of the output signal of the DC elimination filter 2 is reversed according to a result of the positive/negative judgment.

Process c: Positive/negative judgment results are accumulated in all voiced sections. If the polarity of the input signal does not change halfway, the accumulated amount of positive/negative judgment results increases and hence the reliability of the majority decision using positive/negative judgment results increases as time elapses. However, since polarity switching based on positive/negative judgment results should not be made halfway during a voiced section, the calculation processing method for pitch mark estimation is switched or the polarity of the output signal of the DC elimination filter 2 is reversed according to a positive/negative judgment result only at a transition from an unvoiced section to a voiced section. Incidentally, to take into consideration a possibility that the polarity of the input signal changes halfway, a final positive/negative judgment may be made at a transition from an unvoiced section to a voiced section by referring to positive/negative judgments accumulated in a prescribed time, for example, past 5 sec, instead of all positive/negative judgments made in the past.

As described above, according to this mode, since the polarity of an input signal can be judged, pitch marks can be estimated properly even in the case where the polarity of an input signal is unknown.

### Other Embodiments

Although the two embodiments of the disclosure have been described above, other embodiments of the disclosure are conceivable, which will be described below.

(1) In the signal processing device according to the first embodiment, the downsampler 1, the DC elimination filter 2, the harmonics attenuation filters 3_1 to 3_m, the period detectors 4_1 to 4_m, and the selector 5 perform all pieces of computation processing by themselves. However, a configuration is possible in which part of them is performed by another computing device and the signal processing device uses a result of that computation processing. For example, it is possible to have a coprocessor perform pieces of computation processing of the harmonics attenuation filters 3_1 to 3_m and the signal processing device is caused to perform the other pieces of processing utilizing the coprocessor. This also applies to the second embodiment.

(2) A configuration is possible in which application programs for performing respective pieces of processing of the DC elimination filter 2, the harmonics attenuation filters 3_1 to 3_m, the period detectors 4_1 to 4_m, and the selector 5 of the signal processing device according to the first embodiment are stored in a server of an ASP (application service provider) and a user receive desired programs from the server and causes a computer (for example, including a processor and a memory) to run them. This also applies to the second embodiment.

(3) The signal processing device according to the first embodiment may be modified in the following manner. In placed of the period detectors 4_1 to 4_m, m fundamental frequency detectors are provided each which calculates fundamental frequency information based on estimated fundamental period information and outputs it. A selector 5 selects one of the pieces of fundamental frequency information that are output from the m respective fundamental frequency detectors. This also applies to the second embodiment.

The embodiments of the disclosure will be summarized below.

The disclosure provides a signal processing method including: a plurality of harmonics attenuation filtering processes of generating respective signals to be used for estimation of a fundamental frequency of an input signal by performing bandwidth restriction on the input signal according to different bandpass characteristics, wherein in each of the harmonics attenuation filtering processes, a filtering process including an accumulation process and a comb filter process an output signal of one of which becomes an input signal of the other of which is executed once or plural times recursively; wherein the accumulation process accumulates input signals input thereto; and wherein the comb filter process outputs a difference between an input signal to the comb filter process and a signal obtained by delaying the input signal to the comb filter process.

For example, the above signal processing method further includes a plurality of period detection processes which are executed after the harmonics attenuation filtering processes, wherein each of the period detection processes includes: a state detection process of detecting, while selecting a detection target state from plural states relating to an input signal in prescribed order, the detection target state from the input signal; and a period estimation process of estimating a period of the input signal based on state detection times of the state detection process.

For example, in the above signal processing method, if the state detection process detects a succeeding peak from the input signal after detection of a preceding peak and the absolute value of an amplitude of the succeeding peak is smaller than that of an amplitude of the preceding peak to an extent beyond a prescribed limit, the state detection step considers as if to have not detected the succeeding peak.

For example, in the above signal processing method, the period estimation process outputs reliability information indicating a likelihood of a fundamental wave of the input signal.

For example, the above signal processing method further includes: a selection process of receiving pieces of output information including at least estimation results about a fundamental period of the input signal from the respective period detection processes and selecting a fundamental period of the input signal from fundamental periods indicated by the respective pieces of output information, wherein the selection process selects a fundamental period using a cost function that has, as an independent variable, a difference between a fundamental period as a preceding selection result and a fundamental period indicated by output information received from each of the period detection processes, and the cost function being nonlinear with respect to the difference.

The disclosure provides a signal processing device including: a plurality of harmonics attenuation filters configured to have different bandpass characteristics and configured to generate signals to be used for estimation of a fundamental frequency of an input signal by restricting the bandwidth of the input signal, wherein each of the harmonics attenuation filters comprises a filter that has an accumulator and a comb filter which are connected in cascade; wherein the accumulator is configured to accumulate input signals thereto; and wherein the comb filter is configured to output a difference between an input signal to the comb filter and a signal obtained by delaying the input signal to the comb filter.

Each harmonics attenuation filter including the cascade connection of the accumulator and the comb filter as a lowpass filter having a gentle shoulder characteristic and outputs a signal containing a fundamental wave component of the input signal and higher harmonics components that have been attenuated to a proper degree. The higher harmonics components of the output signal of each harmonics attenuation filter are attenuated relative to the fundamental wave component more than those of the input signal, and hence the output signal waveform is more like a fundamental wave than the input signal waveform. Thus, according to this mode of the disclosure, signals that can be used for estimation of a fundamental frequency can be obtained by a small number of harmonics attenuation filter. As a result, the amount of computation or the scale of hardware for estimation of a fundamental frequency can be reduced and a fundamental frequency can be estimated at high speed.

One method for estimating a fundamental frequency of an input signal is to estimate a fundamental period corresponding to the fundamental frequency from an input signal. Where an input signal a fundamental frequency of which is to be estimated contains higher harmonic components, the estimation of a fundamental period may be difficult due to, for example, appearance of peaks that are irrelevant to a fundamental wave component in an input signal waveform because of influence of those higher harmonic components. Thus, where an input signal contains higher harmonic components, an estimator is necessary that is robust to a fundamental period estimation error due to higher harmonics.

In view of the above, the disclosure provides another signal processing device including a memory that stores instructions, and a processor that executes the instructions, wherein, when executed by the processor, the instructions cause the processor to perform operations including: detecting, while selecting a detection target state from plural kinds of states of an input signal in prescribed order, the detection target state from the input signal; and estimating a period of the input signal based on state detection times of the detecting operation.

The disclosure provides another signal processing method including: a state detection process of detecting, while selecting a detection target state from plural kinds of states of an input signal in prescribed order, the detection target state from the input signal; and a period estimation process of estimating a period of the input signal based on state detection times of the state detection process.

According to this mode of the disclosure, since a detection target state is detected from an input signal while it is detected from plural kinds of states of the input signal in prescribed order, times of appearance of various states that are useful for estimation of a fundamental period can be detected while influence of higher harmonic components contained in the input signal is avoided. As a result, fundamental period estimation can be realized that is robust to a fundamental period estimation error due to higher harmonics.

Where a fundamental period estimator/fundamental period estimating operation for estimating a fundamental period based on an input signal waveform is used, the probability that a higher harmonic component is erroneously recognized as a fundamental wave component becomes higher as high harmonic components or noise contained in the input signal becomes stronger or more influential. One countermeasure is a configuration in which an input signal is given to plural harmonics attenuation filters having different bandpass characteristics, output signals of the harmonics attenuation filters are given to plural fundamental period estimator/plural fundamental period estimating operations, respectively, and one of fundamental periods estimated by the respective fundamental period estimators/respective fundamental period estimating operations is selected so that temporal continuity between fundamental periods is maintained.

According to this configuration, even if erroneous estimation of a fundamental period occurs in part of the fundamental period estimator/fundamental period estimating operation, selection of an erroneously estimated fundamental period can be prevented because a fundamental period estimated by another fundamental period estimator/another fundamental period estimating operation is selected so that temporal continuity between fundamental periods is maintained.

However, where an input signal whose fundamental period is to be estimated is, for example, a sound signal having a large frequency variation, an erroneous fundamental period may be selected though the fundamental period is varying actually because priority is given to temporal continuity between fundamental periods.

In view of the above, the disclosure provides another signal processing device including: a memory that stores instructions, and a processor that executes the instructions, wherein, when executed by the processor, the instructions cause the processor to perform operations including: receiving, from a plurality of fundamental wave estimators, pieces of fundamental wave information that are estimation results relating to a fundamental wave component of an input signal; and selecting one of the pieces of fundamental wave information, wherein in the selecting operation, one of the pieces of fundamental wave information is selected using a cost function that has, as an independent variable, a difference between fundamental wave information as a preceding selection result and fundamental wave information received from each of the plural fundamental wave estimators, and the cost function being nonlinear with respect to the difference.

The disclosure provides another signal processing method including: a selection process of receiving, from a plurality of fundamental wave estimators, pieces of fundamental wave information that are estimation results relating to a fundamental wave component of an input signal and selecting one of the pieces of fundamental wave information, wherein the selection process selects one of the pieces of fundamental wave information using a cost function that has, as an independent variable, a difference between fundamental wave information as a preceding selection result and fundamental wave information received from each of the fundamental wave estimators, and the cost function being nonlinear with respect to the difference.

The term “fundamental wave information” as used above means information indicating, for example, a fundamental period or a fundamental frequency. This mode of the disclosure makes it possible to select fundamental wave information properly while allowing a temporal variation of fundamental wave information within an allowable range and, on the other hand, maintaining its temporal continuity.

Among signal processing techniques relating to a sound signal are ones that utilize pitch marks. In the signal processing techniques utilizing pitch marks, in the case where the fundamental period of a sound signal varies continuously over time, high-quality signal processing cannot be attained unless pitch marks used match the fundamental period of the sound signal. However, no pitch mark estimator/no pitch mark estimating operation have been proposed yet that can produce pitch marks that well match the fundamental period of a sound signal.

In view of the above, the disclosure provides a further signal processing device including: a plurality of harmonics attenuation filters configured to have different bandpass characteristics and perform bandwidth restriction on an input signal and produce bandwidth-restricted output signals; a memory that stores instructions, and a processor that executes the instructions, wherein, when executed by the processor, the instructions cause the processor to perform operations including: estimating fundamental wave components of the input signal based on the output signals of the plural harmonics attenuation filters, respectively; estimating a pitch mark in each period of the fundamental wave component estimated by the associated one of the estimating operations of the fundamental wave components, based on the output signal of the associated one of the harmonics attenuation filters; and selecting a fundamental wave component and a pitch mark that are estimated based on an output signal of a common harmonics attenuation filter from the fundamental wave components estimated by the respective estimating operations of the fundamental wave components and the pitch marks estimated by the respective estimating operations of the pitch mark.

The disclosure provides a further signal processing method including: a plurality of harmonics attenuation filtering processes of performing bandwidth restriction on an input signal according to different bandpass characteristics and producing bandwidth-restricted output signals; a plurality of fundamental wave estimation processes of estimating fundamental wave components of the input signal based on the output signals of the plural harmonics attenuation filtering processes, respectively; a plurality of pitch mark estimation processes, each of which estimates a pitch mark in each period of the fundamental wave component estimated by the associated one of the plural fundamental wave estimation processes, based on the output signal of the associated one of the plural harmonics attenuation filtering processes; and a selection process of selecting a fundamental wave component and a pitch mark that are estimated based on an output signal of a common harmonics attenuation filtering process from the fundamental wave components estimated by the plural respective fundamental wave estimation processes and the pitch marks estimated by the plural respective pitch mark estimation processes.

For example, in the above signal processing method, each of the pitch mark estimation processes estimates, as a pitch mark, a time that is at a middle of times of a negative peak and a positive-going zero-cross point of the output signal of the associated harmonics attenuation filtering process.

For example, the above signal processing method further includes: a polarity judging process of judging a polarity of an input signal of the plural harmonics attenuation filtering processes by comparing a difference between a maximum value and a minimum value of the input signal of the plural harmonics attenuation filtering processes in each of a positive interval and a negative interval of a selected one of output signals of the harmonics attenuation filtering processes, wherein each of the plural pitch mark estimation processes estimates a pitch mark according to a judgment result of the polarity judging process.

According to this mode of the disclosure, pitch marks that well match the fundamental period of an input signal even in a case that the fundamental period varies temporarily. As a result, the quality of signal processing utilizing pitch marks can be enhanced.

The disclosure makes it possible to obtain signals that can be used for estimation of a fundamental frequency by harmonics attenuation filtering steps. As such, the disclosure is useful because it makes it possible to reduce the amount of computation or hardware for estimation of a fundamental frequency and to estimate a fundamental frequency at high speed.

What is claimed is:

1. A signal processing method comprising:
a plurality of harmonics attenuation filtering processes of generating respective signals to be used for estimation of a fundamental frequency of an input signal by performing bandwidth restriction on the input signal according to different bandpass characteristics,
wherein in each of the harmonics attenuation filtering processes, a filtering process including an accumulation process and a comb filter process an output signal of one of which becomes an input signal of the other of which is executed once or plural times recursively;
wherein the accumulation process accumulates input signals input thereto; and
wherein the comb filter process outputs a difference between an input signal to the comb filter process and a signal obtained by delaying the input signal to the comb filter process.

2. The signal processing method according to claim 1, further comprising:
a plurality of period detection processes which are executed after the harmonics attenuation filtering processes,
wherein each of the period detection processes comprises:
a state detection process of detecting, while selecting a detection target state from plural states relating to an input signal in prescribed order, the detection target state from the input signal; and
a period estimation process of estimating a period of the input signal based on state detection times of the state detection process.

3. The signal processing method according to claim 2, wherein if the state detection process detects a succeeding peak from the input signal after detection of a preceding peak and an absolute value of an amplitude of the succeeding peak is smaller than that of an amplitude of the preceding peak to an extent beyond a prescribed limit, the state detection process considers as if to have not detected the succeeding peak.

4. The signal processing method according to claim 2, wherein the period estimation process outputs reliability information indicating a likelihood of a fundamental wave of the input signal.

5. The signal processing method according to claim 2, further comprising:
a selection process of receiving pieces of output information including at least estimation results about a fundamental period of the input signal from the respective period detection processes and selecting a fundamental period of the input signal from fundamental periods indicated by the respective pieces of output information,
wherein the selection process selects a fundamental period using a cost function that has, as an independent variable, a difference between a fundamental period as a preceding selection result and a fundamental period indicated by output information received from each of the period detection processes, and the cost function being nonlinear with respect to the difference.

6. A signal processing method comprising:
a state detection process of detecting, while selecting a detection target state from plural kinds of states of an input signal in prescribed order, the detection target state from the input signal; and
a period estimation process of estimating a period of the input signal based on state detection times of the state detection process.

7. A signal processing method comprising:
a selection process of receiving, from a plurality of fundamental wave estimators, pieces of fundamental wave information that are estimation results relating to a fundamental wave component of an input signal and selecting one of the pieces of fundamental wave information,
wherein the selection process selects one of the pieces of fundamental wave information using a cost function that has, as an independent variable, a difference between fundamental wave information as a preceding selection result and fundamental wave information received from each of the fundamental wave estimators, and the cost function being nonlinear with respect to the difference.

8. A signal processing method comprising:
a plurality of harmonics attenuation filtering processes of performing bandwidth restriction on an input signal according to different bandpass characteristics and producing bandwidth-restricted output signals;
a plurality of fundamental wave estimation processes of estimating fundamental wave components of the input signal based on the output signals of the plural harmonics attenuation filtering processes, respectively;
a plurality of pitch mark estimation processes, each of which estimates a pitch mark in each period of the fundamental wave component estimated by the associated one of the plural fundamental wave estimation processes, based on the output signal of the associated one of the plural harmonics attenuation filtering processes; and
a selection process of selecting a fundamental wave component and a pitch mark that are estimated based on an output signal of a common harmonics attenuation filtering process from the fundamental wave components estimated by the plural respective fundamental wave estimation processes and the pitch marks estimated by the plural respective pitch mark estimation processes.

9. The signal processing method according to claim 8, wherein each of the pitch mark estimation processes estimates, as a pitch mark, a time that is at a middle of times of a negative peak and a positive-going zero-cross point of the output signal of the associated harmonics attenuation filtering process.

10. The signal processing method according to claim 8, further comprising:
a polarity judging process of judging a polarity of an input signal of the plural harmonics attenuation filtering processes by comparing a difference between a maximum value and a minimum value of the input signal of the plural harmonics attenuation filtering processes in each of a positive interval and a negative interval of a selected one of output signals of the harmonics attenuation filtering processes,
wherein each of the plural pitch mark estimation processes estimates a pitch mark according to a judgment result of the polarity judging process.

11. A signal processing device comprising:
a plurality of harmonics attenuation filters configured to have different bandpass characteristics and configured to generate signals to be used for estimation of a fundamental frequency of an input signal by restricting the bandwidth of the input signal,
wherein each of the harmonics attenuation filters comprises a filter that has an accumulator and a comb filter which are connected in cascade;
wherein the accumulator is configured to accumulate input signals thereto; and
wherein the comb filter is configured to output a difference between an input signal to the comb filter and a signal obtained by delaying the input signal to the comb filter.

12. A signal processing device comprising:
a memory that stores instructions, and
a processor that executes the instructions,
wherein, when executed by the processor, the instructions cause the processor to perform operations comprising: detecting, while selecting a detection target state from plural kinds of states of an input signal in prescribed order, the detection target state from the input signal; and
estimating a period of the input signal based on state detection times of the detecting operation.

13. A signal processing device comprising:
a memory that stores instructions, and
a processor that executes the instructions,
wherein, when executed by the processor, the instructions cause the processor to perform operations comprising:
receiving, from a plurality of fundamental wave estimators, pieces of fundamental wave information that are estimation results relating to a fundamental wave component of an input signal; and
selecting one of the pieces of fundamental wave information,
wherein in the selecting operation, one of the pieces of fundamental wave information is selected using a cost function that has, as an independent variable, a difference between fundamental wave information as a preceding selection result and fundamental wave information received from each of the plural fundamental wave estimators, and the cost function being nonlinear with respect to the difference.

14. A signal processing device comprising:
a plurality of harmonics attenuation filters configured to have different bandpass characteristics and perform bandwidth restriction on an input signal and produce bandwidth-restricted output signals;
a memory that stores instructions, and
a processor that executes the instructions,
wherein, when executed by the processor, the instructions cause the processor to perform operations comprising:
estimating fundamental wave components of the input signal based on the output signals of the plural harmonics attenuation filters, respectively;
estimating a pitch mark in each period of the fundamental wave component estimated by the associated one of the estimating operations of the fundamental wave components, based on the output signal of the associated one of the harmonics attenuation filters; and
selecting a fundamental wave component and a pitch mark that are estimated based on an output signal of a common harmonics attenuation filter from the fundamental wave components estimated by the respective estimating operations of the fundamental wave components and the pitch marks estimated by the respective estimating operations of the pitch mark.
